(19) United States
(12) Patent Application Publication
(10) Pub. No.: US 2009/0027596 A1
(43) Pub. Date: Jan. 29, 2009

(54) POLARIZING PLATE LAMINATED WITH A RETARDATION LAYER, LIQUID CRYSTAL PANEL, AND LIQUID CRYSTAL DISPLAY APPARATUS

(75) Inventors: Yuusuke Toyama, Osaka (JP); Naoyuki Nitta, Osaka (JP); Masayuki Satake, Osaka (JP); Hironori Motomura, Osaka (JP); Yoshifumi Yamamoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/911,989

(22) PCT Filed: Feb. 7, 2007
(86) PCT No.: PCT/JP2007/052655

§ 371 Date: Oct. 19, 2007

(30) Foreign Application Priority Data
Feb. 24, 2006 (JP) 2006-48535
Feb. 24, 2006 (JP) 2006-48536

(51) Int. Cl. G02F 1/13363; G02F 1/13

(52) U.S. Cl. 349/75; 349/194

(57) ABSTRACT

There are provided a polarizing plate laminated with a retardation layer, a liquid crystal panel and a liquid crystal display apparatus each being excellent in screen contrast and being capable of suppressing display unevenness occurring in high-temperature environment. The polarizing plate laminated with a retardation layer includes a pressure-sensitive adhesive layer, a retardation layer including a resin layer and an inclined alignment layer and a polarizer, in this order.

### TECHNICAL FIELD

The present invention relates to a polarizing plate laminated with a retardation layer, and a liquid crystal panel and a liquid crystal display apparatus using the polarizing plate laminated with a retardation layer. More specifically, the present invention relates to a polarizing plate laminated with a retardation layer, a liquid crystal panel, and a liquid crystal display apparatus, being excellent in a screen contrast and being capable of suppressing display unevenness occurring in high-temperature environment.

### BACKGROUND ART

Various polarizing plates laminated with a retardation layer each having a polarizer and a retardation layer in combination are generally used for various image display apparatuses such as a liquid crystal display apparatus and an electroluminescence (EL) display, to thereby obtain optical compensation. For example, there is a polarizing plate having a retardation layer formed of a discotic liquid crystalline compound (e.g., see Patent Document 1).

In the case of using a polarizing plate laminated with a retardation layer for a liquid crystal display apparatus, the polarizing plate is usually attached to a liquid crystal cell via an adhesion layer. However, there is a problem that display unevenness occurs in high-temperature environment. Further, there is a problem that light leakage occurs at an edge of a screen, which degrades contrast.

[Patent Document 1] JP 7-134213 A

### DISCLOSURE OF THE INVENTION

### Problem to be Solved by the Invention

The present invention has been made to solve the above-mentioned conventional problem, and therefore it is an object of the present invention to provide a polarizing plate laminated with a retardation layer being excellent in screen contrast and being capable of suppressing display unevenness occurring in high-temperature environment, and a liquid crystal panel and a liquid crystal display apparatus using the polarizing plate laminated with a retardation layer.

### Means for Solving the Problems

According to one aspect of the invention, a polarizing plate laminated with a retardation layer is provided. The polarizing plate laminated with a retardation layer includes a pressure-sensitive adhesive layer, a retardation layer including a resin layer and an inclined alignment layer and a polarizer, in this order. A holding force (H_{A}) of the pressure-sensitive adhesive layer at 60° C. is 30 μm or less. A slow axis direction of the retardation layer is substantially perpendicular to an absorption axis direction of the polarizer. The inclined alignment layer is formed of a liquid crystalline composition containing a discotic compound, and the discotic compound is aligned to be inclined.

In one embodiment of the invention, a difference (H_{A}−H_{B}) between the holding force (H_{A}) of the pressure-sensitive adhesive layer at 60° C. and a holding force (H_{B}) thereof at 23° C. is 100 μm or less.

In another embodiment of the invention, a moisture content of the pressure-sensitive adhesive layer is 1.0% or less.

In still another embodiment of the invention, a gel fraction of the pressure-sensitive adhesive layer is 75% or more.

In still another embodiment of the invention, the pressure-sensitive adhesive layer is formed by cross-linking a pressure-sensitive adhesive composition at least containing (meth)acrylic polymer (A) and a peroxide (B).

In still another embodiment of the invention, the (meth) acrylic polymer (A) is a copolymer of alkyl(meth)acrylate (a1) and hydroxy-containing (meth)acrylate (a2).

In still another embodiment of the invention, a blending amount of the peroxide (B) is 0.01 to 1 parts by weight with respect to 100 parts by weight of the (meth)acrylic polymer (A).

In still another embodiment of the invention, the pressure-sensitive adhesive composition further contains an isocyanate compound.

In still another embodiment of the invention, a blending amount of the isocyanate compound is 0.04 to 1 parts by weight with respect to 100 parts by weight of the (meth)acrylic polymer (A).

In still another embodiment of the invention, an index ellipsoid of the resin layer has a relationship of nx≧ny>nz.

In still another embodiment of the invention, the rein layer includes a polymer film containing cellulose-based resin.

In still another embodiment of the invention, the discotic compound includes a triphenylene discotic compound.

In still another embodiment of the invention, an in-plane retardation Re[590] of the retardation layer is 20 to 80 nm.

In still another embodiment of the invention, a thickness direction retardation Rth[590] of the retardation layer is 100 to 300 nm.

Instill another embodiment of the invention, an Nz coefficient of the retardation layer is 2 to 8.

In still another embodiment of the invention, an average inclination angle of the retardation layer is 8 to 24°.

In still another embodiment of the invention, the polarizer includes a stretched film mainly containing polyvinyl alcohol resin containing iodine or dichroic dye.

According to another aspect of the invention, a liquid crystal panel is provided. The liquid crystal panel includes a liquid crystal cell, the polarizing plate laminated with a retardation layer which is placed on one side of the liquid crystal cell so that the pressure-sensitive adhesive layer is on the liquid crystal cell side and the polarizing plate laminated with a retardation layer which is placed on another side of the liquid crystal cell so that the pressure-sensitive adhesive layer is on the liquid crystal cell side.

In one embodiment of the invention, the liquid crystal cell is in a TN mode.

According to still another aspect of the invention, a liquid crystal display apparatus is provided. The liquid crystal display apparatus includes the liquid crystal panel.

### EFFECTS OF THE INVENTION

As described above, according to the present invention, by combining a specific retardation layer with a specific pressure-sensitive adhesive layer, a polarizing plate laminated with a retardation layer, a liquid crystal panel, and a liquid crystal display apparatus, being excellent in screen contrast and being capable of suppressing display unevenness occurring in high-temperature environment, can be provided.

### BRIEF DESCRIPTION OF THE DRAWINGS

FIGS. 1(a) and 1(b) are schematic cross-sectional views of a polarizing plate laminated with a retardation layer according to a preferable embodiment of the present invention.

FIGS. 2(a) and 2(b) are exploded perspective views of the polarizing plate laminated with a retardation layer according to the preferable embodiment of the present invention.

FIG. 3 is a schematic view showing a concept of typical production steps of a pressure-sensitive adhesive layer used in the present invention.

FIG. 4 is a schematic view showing a concept of typical production steps of a polarizer used in the present invention.

FIG. 5 is a schematic cross-sectional view of a liquid crystal panel according to a preferable embodiment of the present invention.

FIGS. 6(a) and 6(b) are schematic cross-sectional views illustrating alignment states of liquid crystal molecules of a liquid crystal layer in a case where a liquid crystal panel of the present invention adopts a TN-mode liquid crystal cell.

FIG. 7 is a schematic exploded diagram showing an optical axis relationship of the liquid crystal panel according to a preferable embodiment of the present invention.

FIG. 8 is a schematic view showing a method of measuring a holding force.

FIG. 9(a) is a contrast contour map showing viewing angle dependence of a contrast of a polarizing plate laminated with a retardation layer of Example 1 of the present invention; FIG. 9(b) is a contrast contour map showing viewing angle dependence of a contrast of a polarizing plate laminated with a retardation layer of Example 3 of the present invention; FIG. 9(c) is a contrast contour map showing viewing angle dependence of a contrast of a polarizing plate laminated with a retardation layer of Example 4 of the present invention; and FIG. 9(d) is a contrast contour map showing viewing angle dependence of a contrast of a polarizing plate laminated with a retardation layer of Comparative Example 2.

FIG. 10 (a) is a graph showing polar angle dependence of a contrast ratio of the polarizing plates laminated with a retardation layer of Examples 1, 3, and 4 of the present invention and the polarizing plate of Comparative Example 2; and FIG. 10(b) is a graph showing azimuth angle dependence of a contrast ratio of the polarizing plates laminated with a retardation layer of Examples 1, 3, and 4 of the present invention and the polarizing plate of Comparative Example 2.

FIG. 11(a) is an observed photograph at a time of black image display of the liquid crystal display apparatus of Example 1 of the present invention; FIG. (b) is an observed photograph at a time of black image display of the liquid crystal display apparatus of Example 2 of the present invention; and FIG. (c) is an observed photograph at a time of black image display of the liquid crystal apparatus of Comparative Example 1.

### DESCRIPTION OF REFERENCE NUMERALS

10, 10′ a pressure-sensitive adhesive layer
20, 20′ retardation layer
21, 21′ resin layer
22, 22′ inclined alignment layer
30, 30′ polarizer
40 liquid crystal cell
41, 42 substrate
43 liquid crystal layer
44 spacer
100, 100′ polarizing plate laminated with a retardation layer
101 liquid crystal panel

### BEST MODE FOR CARRYING OUT THE INVENTION

### Definitions of Terms and Symbols

The definitions of terms and symbols of this specification are as follows.

(1) The symbol “nx” refers to a refractive index in a direction providing a maximum in-plane refractive index (that is, a slow axis direction), and the symbol “ny” refers to a refractive index in a direction perpendicular to the slow axis in the same plane (that is, a fast axis direction). The symbol “nz” refers to a refractive index in a thickness direction. Further, the expression “nx=ny”, for example, not only refers to a case where nx and ny are exactly equal but also includes a case where nx and ny are substantially equal. In this specification, the phrase “substantially equal” includes a case where nx and ny differ within a range providing no effects on overall polarizing characteristics of a polarizing plate laminated with a retardation layer in practical use, or a range providing no effects on overall display characteristics of a liquid crystal display panel in practical use.

(2) The term “in-plane retardation Re [590]” refers to an in-plane retardation value of a film (layer) measured at 23° C. by using light having a wavelength of 590 nm. Re [590] can be determined from an equation Re=(nx−ny)×d, where nx and ny represent refractive indices of a film (layer) at a wavelength of 590 nm in a slow axis direction and a fast axis direction, respectively, and d (nm) represents a thickness of the film (layer).

(3) The term “thickness direction retardation Rth [590] ” refers to a thickness direction retardation value measured at 23° C. by using light of a wavelength of 590 nm. Rth [590] can be determined from an equation Rth=(nx−nz)×d, where nx and nz represent refractive indices of a film (layer) at a wavelength of 590 nm in a slow axis direction and a thickness direction, respectively, and d (nm) represents a thickness of the film (layer). Note that the slow axis describes a direction providing a maximum in-plane refractive index.

Hereinafter, the present invention will be described by way of preferable embodiments, but the present invention is not limited to these embodiments.

A. Entire Configuration of a Polarizing Plate Laminated with a Retardation Layer

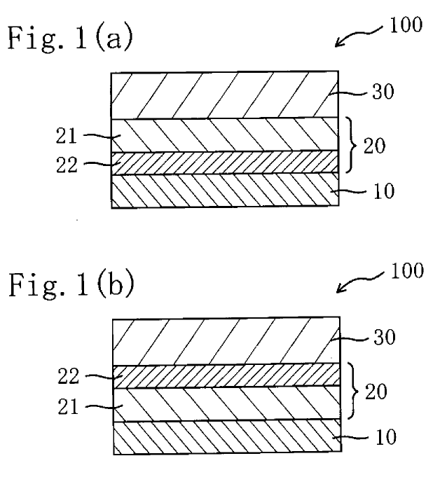

FIGS. 1(a) and 1(b) are schematic cross-sectional views of a polarizing plate laminated with a retardation layer according to a preferable embodiment of the present invention. A polarizing plate laminated with a retardation layer 100 includes a pressure-sensitive adhesive layer 10, a retardation layer 20, and a polarizer 30 in this order. The retardation layer 20 includes a resin layer 21 and an inclined alignment layer 22. In FIG. 1(a), the inclined alignment layer 22 is placed so as to be on the pressure-sensitive adhesive layer 10 side, but the inclined alignment layer 22 may be placed so as to be on the polarizer 30 side, as shown in FIG. 1(b). Preferably, the retardation layer 20 is placed so that the inclined alignment layer 22 is on the pressure-sensitive adhesive layer 10 side. According to such an arrangement, in the case where the polarizing plate is used in a liquid crystal display apparatus, for example, optical compensation of a liquid crystal cell can be conducted appropriately, whereby a liquid crystal display apparatus with a high contrast ratio in front and oblique directions can be obtained.

The slow axis direction of the retardation layer 20 is substantially perpendicular to the absorption axis direction of the polarizer 30 described later. In this specification, the phrase “substantially perpendicular” includes a case where an angle formed by the slow axis direction of the retardation layer 20 and the absorption axis direction of the polarizer 30 is in a range of 90°±2.0°, preferably 90°±1.0°, and more preferably 90°±0.5°.

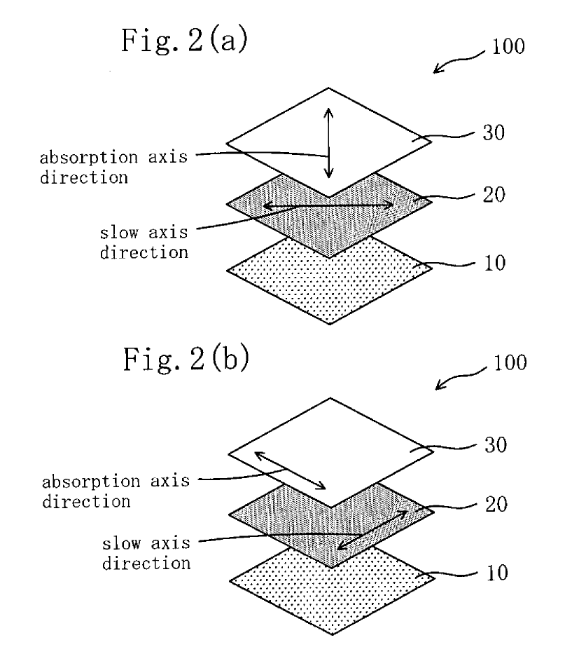

In one embodiment, the slow axis direction of the retardation layer 20 is 45° (or 135°) with respect to one side of the polarizing plate laminated with a retardation layer (see FIG. 2(a)). In another embodiment, the slow axis direction of the retardation layer 20 is 90° (or 0°) with respect to one side of the polarizing plate laminated with a retardation layer (see FIG. 2(b)). Preferably, as shown in FIG. 2(a), the retardation layer 20 is placed so that the slow axis direction thereof is at 45° (or 135°) with respect to one side of the polarizing plate laminated with a retardation layer. In the case where such a polarizing plate laminated with a retardation layer is used in a liquid crystal display apparatus, a contrast ratio in a front direction can be increased remarkably. Further, in the case where a screen is viewed in an oblique direction, a constant contrast ratio can be obtained even when viewed in any azimuth angles of 0° to 360°.

### B. Pressure-Sensitive Adhesive Layer

### B-1. Outline of a Pressure-Sensitive Adhesive Layer

The above-mentioned pressure-sensitive adhesive layer 10 has a holding force (H_{A}) at 60° C. of 300 μm or less, preferably 50 to 300 μm, more preferably 60 to 250 μm, and particularly preferably 70 to 200 μm. When the holding force (H_{A}) is in such a range, display unevenness occurring in high-temperature environment can be suppressed.

The difference (H_{A}−H_{B}) between the holding force (H_{A}) at 60° C. and the holding force (H_{B}) at 23° C. of the above-mentioned pressure-sensitive adhesive layer is preferably 100 μm or less, more preferably 10 to 90 μm, and particularly preferably 20 to 80 μm, and most preferably 30 to 70 μm. If (H_{A}−H_{B}) is in such a range, the display unevenness occurring in high-temperature environment can be suppressed more effectively.

The thickness of the above-mentioned pressure-sensitive adhesive layer can be set appropriately depending on the purpose. The thickness is preferably 2 to 50 μm, more preferably 2 μm to 40 μm, and particularly preferably 5 μm to 35 μm. By setting the thickness in such a range, a pressure-sensitive adhesive layer with appropriate adhesiveness and peelability can be obtained.

The transmittance measured with light having a wavelength of 590 nm at 23° C. of the above-mentioned pressure-sensitive adhesive layer is preferably 90% or more. The theoretical upper limit of the transmittance is 100%, and the practical upper limit is 96%.

The gel fraction of the above-mentioned pressure-sensitive adhesive layer is preferably 75% or more, more preferably 75% to 90%, and particularly preferably 80% to 85%. By setting the gel fraction in the above-mentioned range, a pressure-sensitive adhesive layer with satisfactory tackiness characteristics is obtained. The gel fraction can be appropriately adjusted by selecting the kind, the content, and the like of a cross-linking agent to be used. In general, a portion, in which a polymer of a pressure-sensitive adhesive is cross-linked to form a three-dimensional network structure (also referred to as a gel portion), absorbs a solvent to increase in volume in a case of being soaked in a solvent. This phenomenon is called swelling.

The glass transition temperature (Tg) of the above-mentioned pressure-sensitive adhesive layer is preferably −70° C. to −10° C., more preferably −60° C. to −20° C., and particularly preferably −50° C. to −30° C. By setting the glass transition temperature in the above-mentioned range, a pressure-sensitive adhesive layer having strong adhesiveness with respect to the retardation layer can be obtained. Further, in the case where the polarizing plate is laminated on a substrate (glass plate) of a liquid crystal cell, a pressure-sensitive adhesive layer which has appropriate adhesiveness and is excellent in peelability can be obtained.

The moisture content of the above-mentioned pressure-sensitive adhesive layer is preferably 1.0% or less, more preferably 0.8% or less, particularly preferably 0.6% or less, and most preferably 0.4% or less. The theoretical lower limit value of the moisture content is 0. By setting the moisture content in the above-mentioned range, a pressure-sensitive adhesive layer that is unlikely to generate bubbles even in high-temperature environment can be obtained.

The above-mentioned pressure-sensitive adhesive layer can be formed of any appropriate material, as long as the above-mentioned holding force (H_{A}) can be satisfied. As a specific example, a pressure-sensitive adhesive layer formed by cross-linking a pressure-sensitive adhesive composition will be described. The pressure-sensitive adhesive composition will be described later. In this specification, the term “cross-link” refers to a case where a polymer is chemically cross-linked to form a three-dimensional network structure.

The above-mentioned pressure-sensitive adhesive layer may further contain appropriate optional components. Examples of the optional components include metal powder, glass fibers, glass beads, silica, and a filler. The content of the optional component is preferably more than 0 to 10 parts by weight, more preferably more than 0 to 5 parts by weight with respect to 100 parts by weight of a total solid forming the above-mentioned pressure-sensitive adhesive layer. Further, the above-mentioned pressure-sensitive adhesive layer may contain materials (e.g., a remaining solvent, an additive, an oligomer, etc.) migrated from an adjacent layer.

### B-2. Pressure-Sensitive Adhesive Composition

The pressure-sensitive adhesive composition at least contains a (meth) acrylic polymer (A) and a peroxide (B). The (meth) acrylic polymer (A) refers to a polymer or a copolymer synthesized from an acrylic monomer and/or a methacrylic monomer (referred to as (meth)acrylate in this specification). In the case where the (meth)acrylic polymer (A) is a copolymer, an arrangement state of copolymer molecules is not particularly limited. The copolymer may be a random copolymer, a block copolymer, or a graft copolymer. A preferred molecular arrangement state of the (meth) acrylic polymer (A) is a random copolymer.

The (meth)acrylic polymer (A) is obtained through homopolymerization or copolymerization of alkyl (meth)acrylate (a1).

An alkyl group of alkyl (meth)acrylate (a1) may be linear, branched, or cyclic. The number of carbon atoms in the alkyl group of alkyl (meth)acrylate (a1) is preferably about 1 to 18, and more preferably 1 to 10.

Examples of the above-mentioned alkyl (meth)acrylate (a1) include methyl (meth)acrylate, ethyl (meth)acrylate, propyl (meth)acrylate, n-butyl (meth)acrylate, iso-butyl (meth)acrylate, t-butyl (meth)acrylate, n-pentyl (meth)acrylate, iso-pentyl (meth)acrylate, n-hexyl (meth)acrylate, iso-hexyl (meth)acrylate, n-heptyl (meth)acrylate, iso-heptyl (meth)acrylate, 2-ethylhexyl (meth)acrylate, n-octyl (meth)acrylate, iso-octyl (meth)acrylate, n-nonyl (meth)acrylate, iso-nonyl (meth)acrylate, lauryl (meth)acrylate, stearyl (meth)acrylate, and cyclohexyl (meth)acrylate. One of the may be used alone, or two or more thereof may be used in combination. When using two or more thereof in combination, alkyl group having average of 3 to 9 carbon atoms is preferable for the alkyl (meth)acrylate (a1).

The (meth) acrylic polymer (A) is preferably one of a copolymer of alkyl (meth)acrylate (a1) and hydroxy-containing (meth)acrylate (a2). As such copolymers have excellent reactivity with the peroxide (B), a pressure-sensitive adhesive layer having excellent tackiness may be obtained. In this case, the number of carbon atoms in the alkyl group of alkyl (meth)acrylate (a1) is preferably 1 to 8, more preferably 2 to 8, particularly preferably 2 to 6, and most preferably 4 to 6. The alkyl group of alkyl (meth)acrylate (a1) may be linear or branched.

Specific examples of hydroxy-containing (meth)acrylate (a2) described above include 2-hydroxyethyl (meth)acrylate, 3-hydroxypropyl (meth)acrylate, 2-hydroxypropyl (meth)acrylate, 4-hydroxybutyl (meth)acrylate, 3-hydroxybutyl (meth)acrylate, 2-hydroxybutyl (meth)acrylate, 5-hydroxypentyl (meth)acrylate, 3-hydroxy-3-methylbutyl (meth)acrylate, 6-hydroxyhexyl (meth)acrylate, 7-hydroxyheptyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methylacrylate. One of them may be used alone, or two or more thereof may be used in combination.

The number of carbon atoms in a hydroxyalkyl group of the hydroxyl-containing (meth)acrylate (a2) is preferably equal to or more than the number of carbon atoms in the alkyl group of alkyl (meth)acrylate (a1). The number of carbon atoms in the hydroxyalkyl group of the hydroxyl-containing (meth)acrylate (a2) is preferably 2 to 8, and more preferably 4 to 6. In this way, the number of carbon atoms is adjusted so that reactivity with the peroxide (B) is improved and a pressure-sensitive adhesive layer having much more excellent tackiness may be obtained. Further, reactivity with an isocyanate compound (C) described below can be excellent. In a case where 4-hydroxybutyl (meth)acrylate is used as hydroxy-containing (meth)acrylate (a2), for example, methyl (meth)acrylate, ethyl (meth)acrylate, propyl (meth)acrylate, or butyl (meth)acrylate is preferably used as alkyl (meth)acrylate (a1).

A copolymerization amount of hydroxy-containing (meth)acrylate (a2) is preferably 0.1 to 10 mol %, more preferably 0.2 to 5 mol %, and particularly preferably 0.3 to 1.1 mol %. A copolymerization amount within the above range may provide a pressure-sensitive adhesive layer having excellent adherence, durability, and stress relaxation property.

The (meth)acrylic polymer (A) may be obtained through copolimarization of components other than the above-mentioned alkyl (meth)acrylate (a1) and hydroxy-containing (meth)acrylate (a2). The other components are not particularly limited, but preferred examples thereof include benzyl (meth)acrylate, methoxyethyl (meth)acrylate, ethoxymethyl (meth)acrylate, phenoxyethyl (meth)acrylate, (meth)acrylamide, vinyl acetate, and (meth)acrylonitrile. A copolymerization amount of the other components is preferably 100 parts by weight or less, and more preferably 50 parts by weight or less with respect to 100 parts by weight of alkyl (meth)acrylate (a1).

A weight average molecular weight (Mw) of the (meth) acrylic polymer (A) is preferably 1,000,000 or more, more preferably 1,200,000 to 3,000,000, and particularly preferably 1,200,000 to 2,500,000. Note that, the Mw may be adjusted by appropriately selecting the solvent, the temperature, the additives described below and the like at the time of polymerization.

The (meth)acrylic polymer (A) can be produced by any appropriate method. For example, a radical polymerization method such as a bulk polymerization method, a mass polymerization method, a solution polymerization method, and a suspension polymerization method can be appropriately selected. In the radical polymerization method, any appropriate radical polymerization initiator (e.g., an azo type, a peroxide type) can be used. The reaction temperature is generally about 50° C. to 80° C., and the reaction time is generally 1 to 30 hours.

Among the above-mentioned polymerization methods, the solution polymerization method is preferable. This is because the polymerization temperature can be adjusted with high precision, and a polymer solution after polymerization is easily taken out of a reaction container. Examples of a solvent used in the solution polymerization method generally include ethyl acetate and toluene. The solution concentration is generally about 20 to 80% by weight. The solution polymerization will be described specifically. For example, a monomer is dissolved in a solvent, and a polymerization initiator such as azobisisobutyronitrile is added in an amount of 0.01 to 0.2 parts by weight with respect to 100 parts by weight of a monomer to prepare a solution. After that, in a nitrogen atmosphere, the temperature of the solution is set at 50° C. to 70° C., whereby a reaction is effected for 8 to 30 hours.

The above-mentioned peroxide (B) is not particularly limited as long as a radical is generated by heating to cross-link (meth) acrylic polymer (A). Examples of peroxide (B) include hydroperoxides, diarkylperoxides, peroxyesters, diacylperoxides, peroxydicarbonates, peroxyketals, and ketone peroxides. Specific examples thereof include di(2-ethylhexyl)peroxydicarbonate, di(4-t-butylcyclohexyl)peroxydicarbonate, di-sec-butylperoxydicarbonate, t-butylperoxyneodecanoate, t-hexylperoxypivalate, t-butylperoxypivalate, dilauroylperoxide, di-n-octanoyl peroxide, 1,1,3,3-tetramethylbutylperoxy-2-ethylhexanoate, 1,1,3,3-tetramethylbutylperoxyisobutylate, di(4-methylbenzoyl)peroxide, dibenzoyl peroxide, t-butylperoxybutylate, benzoyl-m-methylbenzoyl peroxide, and m-toluoyl peroxide. Those peroxides may be used alone or in combination of two or more.

Among the above-mentioned peroxides, diacyl peroxides are preferably used, and dibenzoyl peroxide and/or benzoyl m-methylbenzoyl peroxide are used more preferably. This is because these peroxides have a one-minute half-life temperature described later of 90° C. to 140° C., and hence, is excellent in storage stability and is capable of controlling a cross-linking reaction with high precision.

As the above-mentioned peroxide (B), a commercially available product can be used as it is. Specific examples of the commercially available products include PEROYL series (“IB, 335, L, SA, IPP, NPP, TCP, etc.” (product name) produced by NOF Corporation) and NYPER series (“FF, BO, NS, E, BMT-Y, BMT-K40, BMT-M, etc. (product name)) produced by NOF Corporation).

The blending amount of the above-mentioned peroxide (B) is preferably 0.01 to 1 part by weight with respect to 100 parts by weight of the (meth)acrylic polymer (A), more preferably 0.05 to 0.8 parts by weight, particularly preferably 0.1 to 0.5 parts by weight, and most preferably 0.15 to 0.45 parts by weight. By setting the blending amount of the peroxide (B) in the above-mentioned range, the pressure-sensitive adhesive layer can sufficiently achieve the above-mentioned holding force, and further can exhibit appropriate stress relaxation, and excellent heat stability. Consequently, in the case where the pressure-sensitive adhesive layer is used in a liquid crystal display apparatus, the display unevenness occurring in high-temperature environment can be suppressed effectively. By allowing a peroxide to be contained, a pressure-sensitive adhesive layer with a small moisture content can be obtained. It is considered that the small moisture content of the pressure-sensitive adhesive layer also contributes to the reduction in display unevenness of the liquid crystal display apparatus.

It is preferable that the above-mentioned pressure-sensitive adhesive composition can further contain an isocyanate compound. This is because the adherence (which is also referred to as an anchor force) with the retardation layer can be enhanced. Examples of isocyanate compounds include: isocyanate monomer such as tolylene diisocyanate, chlorophenylene duisocyanate, hexamethylene diisocyanate, tetramethylene diisocyanate, isophorone diisocyanate, xylylene diisocyanate, diphenylmethane diisocyanate, trimethylolpropanexylene diisocyanate, and hydrogenated diphenylmethane diisocyanate; adduct isocyanate compounds obtained by adding those isocyanate monomers to a multivalent alcohol such as trimethylolpropane; isocyanurate compounds; biuret type compounds; and urethane prepolymer type isocyanate obtained by addition reaction of any appropriate polyether polyol, polyester polyol, acryl polyol, polybutadiene polyol, polyisoprene polyol, or the like. Those may be used alone or in combination of two or more. Of those, trimethylolpropanexylene diisocyanate is preferably used to improve the adherence between the pressure-sensitive adhesive layer and the retardation layer.

The isocyanate compound may employ a commercially available product as it is. Examples of the commercially available isocyanate compound include: Takenate series (“D-110N, 500, 600, 700, etc.” (product name)) produced by Mitsui Chemicals Polyurethanes, Inc.; and Coronate series (“L, MR, EH, HL, etc.” (product name)) produced by Nippon Polyurethane Industry Co., Ltd.).

The blending amount of the above-mentioned isocyanate compound can be set to be an appropriate amount depending on the purpose. For example, the blending amount is preferably 0.04 to 1 parts by weight, more preferably 0.06 to 0.8 parts by weight, particularly preferably 0.08 to 0.6 parts by weight, and most preferably 0.1 to 0.2 parts by weight with respect to 100 parts by weight of the (meth)acrylic polymer (A). By setting the blending amount of an isocyanate compound in the above-mentioned range, the pressure-sensitive adhesive layer can sufficiently achieve the above-mentioned holding force, and further, can exhibit appropriate stress relaxation and excellent heat stability. Consequently, in the case where the pressure-sensitive adhesive layer is used in a liquid crystal display apparatus, a liquid crystal display apparatus in which the display unevenness occurring in high-temperature environment is small can be obtained. Further, even in severe (high temperature, high humidity) environment, the adherence between the pressure-sensitive adhesive layer and the retardation layer can be satisfactory. It is also considered that the use of a peroxide and an isocyanate compound as a cross-linking agent contributes to the reduction in display unevenness.

It is preferable that the above-mentioned pressure-sensitive adhesive composition can further contain a silane coupling agent. This is because, in the case where the polarizing plate laminated with a retardation layer of the present invention is used in a liquid crystal display apparatus, the adherence between the pressure-sensitive adhesive layer and the liquid crystal cell substrate can be enhanced. As silane coupling agent, a substance having any appropriate functional group can be used. Examples of functional groups include vinyl group, epoxy group, methacryloxy group, amino group, mercapto group, acryloxy group, acetoacetyl group, isocyanate group, styryl group, and polysulfide group. Specific examples of silane-coupling agent include vinyltrimethoxy silane, γ-glycidoxypropyltrimethoxy silane, γ-glycidoxypropylethoxy silane, 3-glycidoxypropylmethyldimethoxy silane, 2-(3,4-epoxycyclohexyl)ethyltrimethoxy silane, p-stylyltrimethoxysilane, γ-methacryloxypropyltrimethoxysilane, γ-acryloxypropyltrimethoxy silane, 3-aminopropyltrimethoxy silane, N-β(aminoethyl)-γ-aminopropyltrimethoxy silane, N-(2-aminoethyl)-3-aminopropylmethyldimethoxy silane, γ-aminopropylmethoxy silane, γ-mercaptopropylmethyldimethoxy silane, bis(triethoxysilylpropyl)tetrasulfide, and γ-isocyanatepropyltrimethoxy silane. Of those, a silane coupling agent having an acetoacetyl group is preferably used to improve the adherence between the pressure-sensitive adhesive layer and the liquid crystal cell substrate.

As the above-mentioned silane coupling agent, a commercially available product can be used as it is. Examples of the commercially available products include KA series (“KA-1003, etc.” (product name)) produced by Shin-Etsu Chemicals Co., Ltd., KBM series (“KBM-303, KBM-403, KBM-503, etc.” (product name)) produced by Shin-Etsu Chemicals Co., Ltd., KBE series (“KBE-402, KBE-502, KBE-903, etc.” (product name)) produced by Shin-Etsu Chemicals Co., Ltd., SH series (“SH6020, SH040, SH6062, etc.” (product name)) produced by Toray Industries, Inc., and SZ series (“SZ6030, SZ6032, SZ6300, etc.” (product name)) produced by Toray Industries, Inc.

The blending amount of the above-mentioned silane coupling agent can be set to be an appropriate amount depending on the purpose. For example, the blending amount is preferably 0.001 to 2 parts by weight, more preferably 0.005 to 2 parts by weight, particularly preferably 0.01 to 1 parts by weight, and most preferably 0.02 to 0.5 parts by weight with respect to 100 parts by weight of the (meth)acrylic polymer (A). By setting the blending amount of the silane coupling agent in the above-mentioned range, the adherence between the pressure-sensitive adhesive layer and the retardation layer can be excellent even in further severe (high temperature, high humidity) environment.

The pressure-sensitive adhesive composition may further contain various additives without departing from the purpose of the present invention. Examples of the additives include a plasticizer, a heat stabilizer, a photo stabilizer, a lubricant, an antioxidant, a UV absorber, a flame retardant, a colorant, an antistatic agent, a compatibilizing agent, a crosslinking agent, a thickener, and a pigment.

A mixing amount of the other additives may be set to any appropriate amount depending on the purpose. The mixing amount thereof is preferably more than 0 and 5 parts by weight or less with respect to 100 parts by weight of the (meth) acrylic polymer (A).

The above-mentioned pressure-sensitive adhesive composition is prepared by, for example, a method including the following Steps 1A and 1B.

Step 1A: step of preparing a polymer solution (1-A) by diluting the above-mentioned (meth)acrylic polymer (A) with a solvent.

Step 1B: step of blending the polymer solution (1-A) obtained in Step 1A with the above-mentioned peroxide (B), and if required, the above-mentioned isocyanate compound and/or the above-mentioned additive.

By using such a method, a more uniform pressure-sensitive adhesive composition is obtained. Herein, as a method of blending each component, a suitable method can be adopted as appropriate. Preferably, the peroxide (B), an isocyanate compound, and a silane coupling agent are added in this order to the polymer solution (1-A). Further, in the case where the (meth)acrylic polymer (A) is polymerized by the solution polymerization method, the obtained reaction solution may be used as it is as the above-mentioned polymer solution (1-A). A diluted solution obtained by adding a solvent to the obtained reaction solution may be used as the polymer solution (1-A).

The solvent used for the above-mentioned preparation is not particularly limited, as long as it can dissolve the (meth) acrylic polymer (A). Specific examples of the solvent include toluene, xylene, chloroform, dichloromethane, dichloroethane, phenol, diethylether, tetrahydrofuran, anisole, tetrahydrofuran, acetone, methylisobutylketone, methylethylketone, cyclohexanone, cyclopentanone, 2-hexanone, 2-pyrolidone, N-methyl-2-pyrolidone, n-butanol, 2-butanol, cyclohexanol, isopropyl alcohol, t-butyl alcohol, glycerin, ethylene glycol, diethyleneglycol dimethyl ether, 2-methyl-2,4-pentadioldimethylformamide, dimethylacetamide, acetonitrile, butylonitrile, methyl cellosolve, methyl cellosolve acetate, ethyl acetate, and butyl acetate. They can be used alone or in combination of at least two kinds. Among them, toluene and ethylacetate are used preferably. This is because they are excellent in productivity, workability, and cost efficiency.

The concentration of the above-mentioned polymer solution (1-A) is preferably 15 to 45% by weight, and more preferably 20 to 40% by weight. By setting the concentration of the polymer solution (1-A) in the above range, the polymer solution (1-A) excellent in a coating property with respect to a substrate, and consequently, a pressure-sensitive adhesive layer excellent in surface uniformity, can be obtained.

### B-3. Method of Cross-Linking a Pressure-Sensitive Adhesive Composition (Method of Forming a Pressure-Sensitive Adhesive Layer)

As a method of cross-linking the above-mentioned pressure-sensitive adhesive composition, any appropriate method can be adopted. Preferably, a method of heating a pressure-sensitive adhesive composition is used. The heating temperature is preferably 50° C. to 200° C., more preferably 70° C. to 190° C., particularly preferably 100° C. to 180° C., and most preferably 120° C. to 170° C. By setting the heating temperature in the above-mentioned range, a cross-linking reaction between the (meth)acrylic polymer (A) and the peroxide (B) is effected rapidly, and consequently, a pressure-sensitive adhesive excellent in tackiness can be obtained. Further, a side reaction can be suppressed. The heating time is not particularly limited, but it is preferably 5 seconds to 20 minutes, more preferably 5 seconds to 10 minutes, and particularly preferably 10 seconds to 5 minutes. By setting the heating time in the above-mentioned range, the cross-linking reaction between the (meth) acrylic polymer (A) and the peroxide (B) is effected efficiently.

As a specific example of the method of forming a pressure-sensitive adhesive layer, there is a method including Steps 1C and 1D below.

Step 1C: step of applying the above-mentioned polymer solution (1-B) onto a substrate.

Step 1D: step of drying the applied substance formed in Step 1C by heating, for example, at 50° C. to 200° C., thereby forming a pressure-sensitive adhesive layer on the surface of the substrate.

Step 1C is conducted for the purpose of deploying the polymer solution thinly on a substrate, thereby obtaining an applied substance in a thin film shape. Step 1D is conducted for the purpose of evaporating a solvent of the applied substance and cross-linking the peroxide with the polymer. Drying in Step 1D may be performed in multiple stages, by using a plurality of temperature control means set at different temperatures. According to such a method, a pressure-sensitive adhesive layer with small variation in thickness is obtained efficiently, and a cross-linking reaction between the peroxide and the polymer is effected appropriately, whereby a pressure-sensitive adhesive layer excellent in tackiness can be obtained.

As a method of applying the polymer solution (1-B) on the substrate, an application method employing any appropriate coater may be used. Examples of the coater include a reverse roll coater, a positive rotation roll coater, a gravure coater, a knife coater, a rod coater, a slot orifice coater, a curtain coater, a fountain coater, an air doctor coater, a kiss coater, a dip coater, a bead coater, a blade coater, a cast coater, a spray coater, a spin coater, an extrusion coater, and a hot melt coater. Preferable examples include a reverse roll coater, a gravure coater, a slot orifice coater, a curtain coater, and a fountain coater, because each of those coaters can provide a coating film having excellent surface uniformity.

As the substrate, any appropriate one can be selected. Preferably, a polymer film is used because the polymer film can be rolled to enhance productivity remarkably. The substrate may be a retardation layer described later. Preferably, a substrate, in which at least the surface (on which the polymer solution (1-B) is applied) is subjected to peeling treatment, is used. This is because the substrate thus subjected to peeling treatment is capable of functioning also as a peeling liner for a polarizing plate laminated with a retardation layer (for a pressure-sensitive adhesive layer). As a specific example, there is a polyethyleneterephthalate film treated with a silicone releasing agent. The peeling liner is generally peeled before the polarizing plate laminated with a retardation layer is put into practical use (before a pressure-sensitive adhesive layer is stacked on an optical component such as a liquid crystal cell.

As temperature control means for heating or drying the above-mentioned pressure-sensitive adhesive composition, a suitable one can be selected as appropriate. Examples of the above-mentioned temperature control means include an air circulation type temperature-controlled oven in which hot air or cold air circulates, a heater using a micro-wave or an infrared ray, a roll heated for regulating temperature, a heat pipe roll, or a metal belt.

### B-4. Lamination of a Pressure-Sensitive Adhesive Layer and a Retardation Layer

The pressure-sensitive adhesive layer obtained in the above-mentioned Steps 1A to 1D is preferably laminated on the retardation layer in advance. For example, the adhesive layer is laminated on the retardation layer by the method including Step 1E below.

Step 1E: step of laminating a pressure-sensitive adhesive layer formed on the surface of the substrate obtained in Step 1D on a retardation layer to obtain a laminate.

According to such a method, a polarizing plate laminated with a retardation layer and a liquid crystal panel, in which optical characteristics of a retardation layer are unlikely to change and which have excellent optical characteristics, can be obtained. Further, a polarizing plate laminated with a retardation layer and a liquid crystal panel, which are excellent in surface uniformity, can be obtained. During laminating, the pressure-sensitive adhesive layer may be laminated on the retardation layer after being peeled from the substrate, may be laminated on the retardation layer while being peeled from the substrate, or may be peeled from the substrate after being laminated on the retardation layer.

In the case where the above-mentioned pressure-sensitive adhesive composition contains an isocyanate compound, the above-mentioned laminating method preferably includes Step 1F below.

Step 1F: step of storing the laminate obtained in Step 1E for at least 3 days.

Step 1F described above is conducted for the purpose of aging the above-mentioned pressure-sensitive adhesive layer. In this specification, the term “aging” refers to a case where diffusion or a chemical reaction of a material contained in a pressure-sensitive adhesive layer is effected to obtain preferable property and state.

The temperature (aging temperature) for aging the above-mentioned pressure-sensitive adhesive layer can be appropriately regulated depending upon the kinds of a polymer and a cross-linking agent, the aging time, and the like. The aging temperature is preferably 10° C. to 80° C., more preferably 20° C. to 60° C., and particularly preferably 20° C. to 40° C. By setting the aging temperature in the above-mentioned range, a pressure-sensitive adhesive layer having stable tackiness can be obtained. The time (aging time) for aging the above-mentioned pressure-sensitive adhesive layer can be regulated appropriately depending upon the kinds of a polymer and a cross-linking agent, the aging temperature, and the like. The aging time is preferably at least 3 days, more preferably at least 5 days, and particularly preferably at least 7 days. By setting the aging time in the above-mentioned range, a pressure-sensitive adhesive layer having stable tackiness can be obtained.

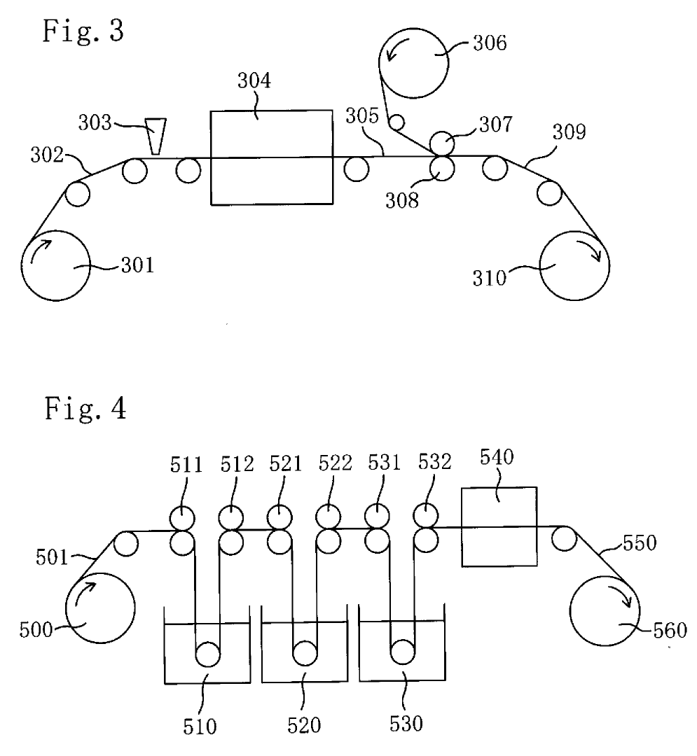

An example of a method of forming the above-mentioned pressure-sensitive adhesive layer will be described with reference to FIG. 3. For example, a substrate 302 is fed from a first feed portion 301, and the above-mentioned polymer solution (1-B) is applied onto the substrate 302 in a coater portion 303. The applied substance on the surface of the substrate is sent to temperature control means (drying means) 304, and heated and dried at for example 50° C. to 200° C., whereby a pressure-sensitive adhesive layer is formed. The retardation layer is fed from a second feed portion 306, and laminated on the pressure-sensitive adhesive layer by laminating rolls 307, 308. A laminate 309 of the retardation layer, the pressure-sensitive adhesive layer, and the substrate 302 thus obtained is taken up by a take-up portion 310. In the case where the substrate 302 is, for example, a polyethyleneterephthalate film treated with a silicone peeling agent, the substrate 302 can be used as a peeling liner as it is.

### C. Retardation Layer

The above-mentioned retardation layer 20 includes a resin layer 21 and an inclined alignment layer 22. Hereinafter, each layer will be described.

### C-1. Resin Layer

As the above-mentioned resin layer 21, any appropriate one can be selected. Preferably, the index ellipsoid of the resin layer has a relationship of nx≧ny>nz. The thickness of the resin layer is preferably 20 to 100 μm. By setting the thickness of the resin layer in such a range, a retardation layer excellent in mechanical strength can be obtained.

Preferably, the resin layer is a polymer film containing a thermoplastic resin. The thermoplastic resin is preferably a cellulose-based resin. As the cellulose-based resin, any appropriate cellulose-based resin can be adopted. Preferably, a cellulose organic acid ester is used, in which a hydroxy group of cellulose is partly or entirely substituted by an acetyl group, a propionyl group and/or a butyl group. Specific examples of the cellulose organic acid ester include cellulose acetate, cellulose propionate, cellulose butylate, cellulose acetate propionate, and cellulose acetate butylate. Such a cellulose-based resin can be obtained by the method described, for example, in [0040] and [0041] of JP 2001-188128 A.

In the case where the above-mentioned cellulose-based resin contains an acetyl group, the acetyl substitution degree is preferably 1.5 to 3.0, more preferably 2.0 to 2.9, and particularly preferably 2.4 to 2.9. In the case where the above-mentioned cellulose-based resin contains a propionyl group, the propionyl substitution degree is preferably 0.5 to 3.0, more preferably 1.0 to 2.9, and particularly preferably 2.3 to 2.8. In the case where the above-mentioned cellulose-based resin contains an acetyl group and a propionyl group, the total of the acetyl substitution degree and the propionyl substitution degree is preferably 1.5 to 3.0, more preferably 2.0 to 3.0, and particularly preferably 2.4 to 2.9. In this case, the acetyl substitution degree is preferably 0.1 to 1.5, and the propionyl substitution degree is preferably 1.5 to 2.9. By using such a cellulose-based resin, a thinner retardation layer, which satisfies a retardation value in a thickness direction described later, can be produced.

The acetyl substitution degree or the propionyl substitution degree refers to the number by which acetyl groups (or propionyl groups) substitute for hydroxy groups attached to carbon at 2, 3, 6-positions in a cellulose backbone. The acetyl groups (or propionyl groups) may substitute for any carbon at 2, 3, 6-positions in a cellulose backbone concentratedly, or may be present evenly. The above-mentioned acetyl substitution degree can be obtained by ASTM-D817-91 (test method for cellulose acetate, etc.). Further, the above-mentioned propionyl substitution degree can be obtained by ASTM-D817-96 (test method for cellulose acetate, etc.).

The above-mentioned polymer film can further contain any appropriate additive. Examples of the additive include a plasticizer, a thermal stabilizer, a photo stabilizer, a lubricant, an antioxidant, an ultraviolet absorber, a flame retarder, a colorant, an antistatic agent, a compatibilizer, a cross-linking agent, and a thickener. The content of an additive can be set to be an appropriate amount depending on the purpose. The content is preferably more than 0 to 20 parts by weight or less with respect to 100 parts by weight of the above-mentioned cellulose-based resin.

As the above-mentioned cellulose-based resin, a commercially available resin can be used as it is. Further, the commercially available resin may be subjected to any appropriate polymer denaturation. Specific examples of the polymer denaturation include copolymerization, cross-linking, denaturation of a molecular terminal, and denaturation of stereoregularity. Specific examples of the commercially available resin include a cellulose acetate propionate resin (307E-09, 360A-09, 360E-16 (product name)) produced by Daicel Finechem Ltd., cellulose acetate (CA-398-30, CA-398-30L, CA-320S, CA-394-60S, CA-398-10, CA-398-3, CA-398-30, CA-398-6 (product name)) produced by Eastman Chemical Company, cellulosebutyrate (CAB-381-0.1, CAB-381-20, CAB-500-5, CAB-531-1, CAB-551-0.2, CAB-553-0.4 (product name)) produced by Eastman Chemical Company, and cellulose acetate propionate (CAP-482-0.5, CAP-482-20, CAP-504-0.2 (product name)) produced by Eastman Chemical Company.

The weight-average molecular weight (Mw) of the above-mentioned cellulose-based resin is preferably 20,000 to 1000,000, more preferably 25,000 to 800,000, and particularly preferably 30,000 to 600,000. In the weight-average molecular weight in the above range, resin having excellent mechanical strength, and satisfactory solubility, forming property, and flow casting workability can be obtained.

A glass transition temperature (Tg) of the above-mentioned cellulose-based resin is preferably 110 to 185° C., more preferably 120 to 170° C., and particularly preferably 125 to 150° C. Tg of 110° C. or higher facilitates formation of a polymer film with favorable thermal stability, and Tg of 185° C. or lower facilitates formation of a resin with excellent forming property.

As a method of obtaining the above-mentioned polymer film, any appropriate forming method can be adopted. Examples of the forming method include compression molding, transfer molding, injection molding, extrusion, blow molding, powder molding, FRP molding, and solvent casting. Among them, solvent casting is preferable. This is because a polymer film excellent in smoothness and optical uniformity can be obtained.

As the above-mentioned polymer film, a commercially available product can be used as it is. Further, the commercially available product may be subjected to secondary treatment such as stretching and contraction. Specific examples of the commercially available product include FUJITAC series (ZRF80S, TD80UF (product name)) produced by Fujifilm Corporation, and “KC8UX2M” (product name) produced by Konica Minolta Opto, Inc.

### C-2. Inclined Alignment Layer

The above-mentioned inclined alignment layer 22 is formed of a liquid crystalline composition containing a discotic compound, and the discotic compound is aligned so as to be inclined. By providing a retardation layer containing such an inclined alignment layer, a polarizing plate laminated with a retardation layer and a liquid crystal panel excellent in screen contrast can be obtained. In this specification, the term “liquid crystalline composition” refers to a substance that shows a liquid crystal phase and exhibits liquid crystallinity. “Inclined alignment” may be a state (so-called inclined uniaxial alignment) in which liquid crystal molecules are aligned at a constant angle and arranged in the same direction, or may be a state (so-called hybrid alignment) in which the inclination angle (tilt angle) of liquid crystal molecules increases or decreases continuously or intermittently in the thickness direction.

The thickness of the above-mentioned inclined alignment layer is preferably 1 to 5 μm. By setting the thickness of the inclined alignment layer in such a range, intended optical characteristics (retardation) can be obtained. Further, the use of such an inclined alignment layer in a liquid crystal panel can contribute to thinning of the panel.

As the above-mentioned discotic compound, any appropriate compound can be adopted, as long as it contains liquid crystal molecules having a disc-shaped core and shows a disc phase and/or a discotic nematic phase. The discotic compound typically contains molecules in which 2 to 8 side chains are radially bonded to a disc-shaped center core by an ether bond or an ester bond. Examples of the center core include benzene, triphenylene, toluxene, pyrane, Le Figarole, porphyrin, and a metal complex, described in “Liquid Crystal Dictionary” (1989) page 22, FIG. 1, Baifukan Co., Ltd. The discotic compound is preferably a triphenylene compound having triphenylene as a center core. Above all, the triphenylene compound represented by the following General Formula (I) is used preferably.

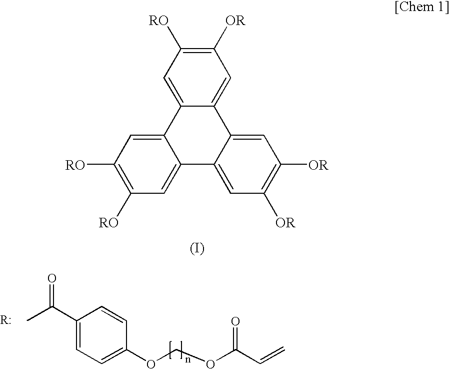

where n is an integer of 2 to 10, preferably 4 to 8, more preferably 4 to 6, and particularly preferably 6.

As a method of aligning the above-mentioned discotic compound so as to be inclined, any appropriate alignment method can be adopted. Specific examples of the alignment method include oblique deposition, optical alignment, and rubbing. The oblique deposition is typically a method of depositing an oxide such as silicon oxide on a substrate in an oblique direction. According to this method, by selecting a deposition angle, a deposition number, and the like, the inclination angle of liquid crystal molecules can be regulated appropriately. The optical alignment is a method of irradiating an optically reactive alignment film formed on the surface of a substrate with polarized light or non-polarized light in an oblique direction, for example, as described in “Functional Material” Vol. 25, No. 12 (2005), pages 15 to 21, CMC Publishing Co., Ltd. According to this method, by selecting an irradiation angle, an irradiation time, and the like of polarized light or non-polarized light, the inclination angle of liquid crystal molecules can be regulated appropriately. The rubbing is a method of rubbing the surface of a substrate or an alignment film with cloth such as cotton, nylon, or rayon in one direction.

The above-mentioned inclined alignment layer 22 is practically a layer obtained by immobilizing a liquid crystalline composition aligned so as to be inclined. Specific examples of immobilizing include solidification and curing. Solidification refers to coagulating a liquid crystalline composition in a softened, molten, or solution state by cooling. Curing refers to cross-linking a part or an entirety of a liquid crystalline composition with heat, a catalyst, light, and/or a radiation to put the liquid crystalline composition in an insoluble and infusible state or in a slightly soluble and slightly melting state. Thus, the immobilized liquid crystalline composition may not exhibit liquid crystallinity. A specific example of the case where the immobilized liquid crystalline composition does not exhibit liquid crystallinity includes the case where a liquid crystalline composition forms a network structure by photopolymerization or the like.

As a method of immobilizing the above-mentioned liquid crystalline composition, any appropriate method can be adopted. Hereinafter, each of a solidifying method and curing method will be described specifically.

As a method of solidifying the above-mentioned liquid crystalline composition, for example, a method including Steps 2A to 2C below can be used.

Step 2A: step of subjecting the surface of a substrate (support) to alignment treatment.

Step 2B: step of applying a solution or a dispersion of a liquid crystalline composition onto the surface of the substrate subjected to alignment treatment, and aligning the liquid crystalline composition.

Step 2C: step of drying the liquid crystalline composition to form a solidified layer.

As a method of curing the above-mentioned liquid crystalline composition, for example, a method further including Step 2D below in addition to Steps 2A to 2C described above can be used.

Step 2D: step of irradiating the solidified layer obtained in Step 2C described above with UV-rays to cure the liquid crystalline composition.

In this case, it is preferable to use a discotic compound exhibiting photocrosslinkability, or to add a photocrosslinkable compound to the above-mentioned liquid crystalline composition.

An example of the above-mentioned discotic compound exhibiting photocrosslinkability includes a triphenylene compound represented by the above-mentioned General Formula (I). Examples of the above-mentioned photocrosslinkable compound include monofunctional, difunctional, or trifunctional acrylic resins.

As the retardation layer 20 including the resin layer 21 and the inclined alignment layer 22, a commercially available product can be used as it is. Alternatively, a commercially available product subjected to any appropriate secondary treatment can also be used. Examples of the commercially available product include WV film series and the like, produced by Fujifilm Corporation. Among them, WV film EA is used preferably.

The above-mentioned retardation layer 20 may further include optional layers. For example, the retardation layer 20 may include an alignment layer for aligning a liquid crystalline composition forming the inclined alignment layer 22 between the resin layer 21 and the inclined alignment layer 22. Further, the retardation layer 20 may include an adhesion layer and an anchor coat layer for attaching each layer. Further, the retardation layer may be subjected to surface treatment. By conducting surface treatment, the adherence between the above-mentioned pressure-sensitive adhesive layer 10 and the polarizer 30 can be enhanced. Specific examples of the surface treatment include corona treatment, plasma treatment, and glow discharge treatment.

### C-3. Lamination of a Resin Layer and an Inclined Alignment Layer

As a method of laminating the above-mentioned resin layer and the above-mentioned inclined alignment layer, any appropriate method can be adopted. As a specific example of the laminating method, there is a method of applying an application solution (a solution or a dispersion of the above-mentioned liquid crystalline composition) forming an inclined alignment layer onto the surface of a resin layer, followed by immobilizing. Preferably, before applying the application solution, an alignment film for aligning the above-mentioned liquid crystalline composition is formed in advance on the above-mentioned resin layer. As another laminating method, there is a method of applying the above-mentioned application solution onto a substrate (e.g., polystyreneterephtharate, etc.), followed by immobilizing, to form an inclined alignment layer, and transferring the inclined alignment layer to the surface of the above-mentioned resin layer via an adhesion layer. In this case, on the surface of the resin layer, to which the inclined alignment layer is to be transferred, an anchor coat layer may be formed in advance, or the surface of the resin layer may be subjected to any appropriate surface treatment. A specific example of the surface treatment includes corona treatment. The substrate is generally peeled before/after the transfer or simultaneously with the transfer.

### C-4. Optical Characteristics of a Retardation Layer

Re[590] of the above-mentioned retardation layer 20 can be set to be any appropriate value depending on the purpose. Re[590]is preferably 20 to 80 nm, more preferably 28 to 70 nm, and particularly preferably 36 to 60 nm. By setting Re[590] in the above-mentioned range, a liquid crystal display apparatus with a constant contrast ratio even when viewed from any azimuth angles of 0° to 360° in the case where a screen is viewed in an oblique direction can be obtained. Re[590] can be regulated to a desired value by appropriately selecting the average inclination angle and thickness of the retardation layer, and the kind, blending amount, and the like of the above-mentioned discotic compound.

Rth[590] of the above-mentioned retardation layer can be set to be any appropriate value depending on the purpose. Rth[590] is preferably 100 to 300 nm, more preferably 110 to 190 nm, and particularly preferably 120 to 180 nm. By setting Rth[590] in the above-mentioned range, a liquid crystal display apparatus with a constant contrast ratio even when viewed from any azimuth angles of 0° to 3600 in the case where a screen is viewed in an oblique direction can be obtained. Rth[590] can be regulated to a desired value by appropriately selecting the thickness of the retardation layer, and the kind, blending amount, and the like of the additive added to the retardation layer.

An Nz coefficient of the above-mentioned retardation layer can be set to be any appropriate value depending on the purpose. The Nz coefficient is preferably 2 to 8, more preferably 2 to 6, particularly preferably 2 to 4.2, and most preferably 2 to 4. The Nz coefficient is a value calculated from an expression Rth[590]/Re[590]. By setting the Nz coefficient in the above-mentioned range, a liquid crystal display apparatus with a constant contrast ratio even when viewed from any azimuth angles of 0° to 360° in the case where a screen is viewed in an oblique direction can be obtained. The Nz coefficient can be regulated by appropriately selecting the average inclination angle and thickness of the retardation layer, and the kind, blending amount, and the like of the above-mentioned discotic compound.

The average inclination angle of the above-mentioned retardation layer can be set to be any appropriate value depending on the purpose. The average inclination angle is preferably 8 to 24°, more preferably 10 to 20°, particularly preferably 12 to 18°, and most preferably 14 to 18°. By setting the average inclination angle in such a range, a liquid crystal display apparatus with a high contrast ratio in an oblique direction can be obtained. In this specification, the term “average inclination angle” refers to a statistical average value of inclination angles of the respective molecules of the discotic compound.

### D. Polarizer

In this specification, the polarizer refers to an element capable of converting natural light or polarized light into any appropriate polarized light. As the above-mentioned polarizer 30, any appropriate polarizer can be adopted depending on the purpose. Preferably, the polarizer converts natural light or polarized light into linearly polarized light. Such a polarizer splits incident light into two polarized components perpendicular to each other, passes one polarized component, and absorbs, reflects, and/or scatters the other polarized component. The thickness of the above-mentioned polarizer is preferably 5 to 50 μm, and more preferably 20 to 40 μm.

The transmittance (hereinafter, referred to as a single axis transmittance) measured with light having a wavelength of 550 nm at 23° C. of the above-mentioned polarizer is preferably at least 40%, and more preferably at least 42%. The theoretical upper limit of the single axis transmittance is 50%, and the upper limit is practically 46%.

The polarization degree measured with light having a wavelength of 550 nm at 23° C. of the above-mentioned polarizer is preferably at least 99.8%, and more preferably at least 99.9%. By setting the polarization degree in the above-mentioned range, a liquid crystal display apparatus with a high contrast ratio in a front direction can be obtained. The theoretical upper limit of the above-mentioned polarization degree is 100%.

The hue under the National Bureau of Standards (NBS) of the above-mentioned polarizer; a-value (single axis a-value) is preferably at least 2.0, and more preferably at least −1.8. The hue under the National Bureau of Standards (NBS) of the above-mentioned polarizer; b-value (single axis b-value) is preferably 4.2 or less, and more preferably 4.0 or less. If the a-value and the b-value of the polarizer are set to be close to 0, a display apparatus providing a display image with vivid color can be obtained. Thus, the ideal a-value and b-value are 0.

As the above-mentioned polarizer, any appropriate film can be selected. The polarizer is preferably a stretched film mainly containing polyvinyl alcohol-based resin containing iodine or a dichromatic dye. In this specification, the term “stretched film” refers to a polymer film obtained by applying a tension to an unstreched film at an appropriate temperature and enhancing the orientation of molecules in the tension direction.

The polyvinyl alcohol-based resin to be used may be prepared by saponificating the polymer obtained by polymerizing a vinyl ester-based monomer. Examples of the vinyl ester-based monomer include vinyl formate, vinyl acetate, vinyl propionate, vinyl valerate, vinyl laurate, vinyl stearate, vinyl benzoate, vinyl pivalate, and vinyl versatate.

An average degree of polymerization of the polyvinyl alcohol-based resin may be selected appropriately depending on the purpose. The average degree of polymerization is preferably 1,200 to 3,600. The average degree of polymerization can be determined through a method in accordance with JIS K6726-1994.

A degree of saponification of the polyvinyl alcohol-based resin is preferably 95.0 mol % to 99.9 mol %. By setting the degree of saponification within the above-mentioned range, a polarizer excellent in durability can be obtained. The degree of saponification may be determined in accordance with JIS K6726-1994.

The polymer film mainly containing the above-mentioned polyvinyl alcohol-based resin preferably contains polyvalent alcohol as a plasticizer. This is because the film can obtain further improved stainability and stretching property. Examples of the polyvalent alcohol include ethylene glycol, glycerin, propylene glycol, diethylene glycol, triethylene glycol, tetraethylene glycol, and trimethylolpropane. One kind of polyvalent alcohol may be used independently, or two or more kinds thereof may be used in combination. A content of the polyvalent alcohol is preferably more than 0 to 30 parts by weight or less with respect to 100 parts by weight of polyvinyl alcohol-based resin.

The polymer film mainly containing the above-mentioned polyvinyl alcohol-based resin can preferably contain a surfactant. This is because the surfactant further enhances the stainability and stretching property of a film. The surfactant is preferably a non-ionic surfactant. Examples of the non-ionic surfactant include diethanolamide laurate, coconut oil fatty acid diethanolamide, coconut oil fatty acid monoathanolamide, monoisopropanolamide laurate, and monoisopropanolamide oleate. The content of the surfactant is preferably more than 0 to 5 parts by weight with respect to 100 parts by weight of polyvinyl alcohol-based resin.

As a method of obtaining the polymer film mainly containing the above-mentioned polyvinyl alcohol-based resin, any appropriate forming method can be adopted. As a specific example of the forming method, there is a method described in JP 2000-315144 A [Example 1].

As the polymer film mainly containing the above-mentioned polyvinyl alcohol-based resin, a commercially available product can be used as it is. Specific examples of the commercially available product include “Kuraray Vinylone Film” (product name) produced by Kuraray Co., Ltd., “Tohcello Vinylone Film” (product name) produced by Tohcello Co., Ltd., and “Nichigo Vinylone Film” (product name) produced by The Nippon Synthetic Chemical Industry, Co., Ltd.

Any appropriate substance may be employed as the dichromatic dye. In this specification, the term “dichromatic” refers to optical anisotropy in which light absorption differs in two directions of an optical axis direction and a direction perpendicular thereto. Examples of the dichromatic dye include Red BR, Red LR, Red R, Pink LB, Rubin BL, Bordeaux GS, Sky Blue LG, Lemon Yellow, Blue BR, Blue 2R, Navy RY, Green LG, Violet LB, Violet B, Black H, Black B, Black GSP, Yellow 3G, Yellow R, Orange LR, Orange 3R, Scarlet GL, Scarlet KGL, Congo Red, Brilliant Violet BK, Supra Blue G, Supra Blue GL, Supra Orange GL, Direct Sky Blue, Direct Fast Orange S, and Fast Black.

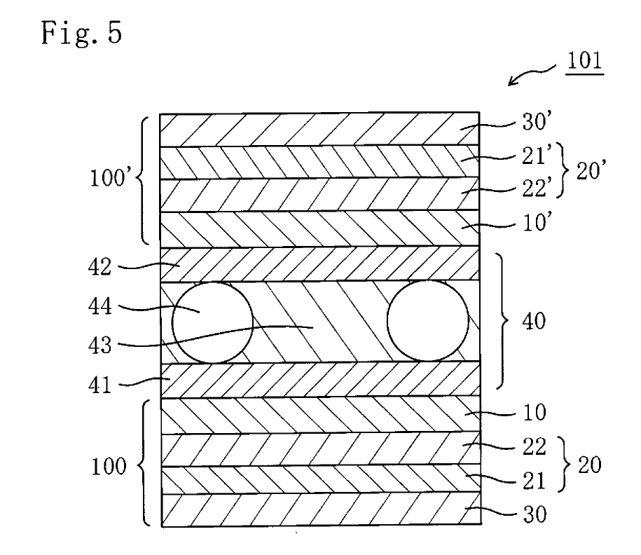

An example of a method of producing the above-mentioned polarizer will be described referring to FIG. 4. For example, a polymer film 501 containing a polyvinyl alcohol-based resin as a main component is fed from a feed part 500, immersed in an aqueous iodine solution bath 510, and subjected to swelling and coloring treatment under tension in a longitudinal direction of the film by rollers 511 and 512 at different speed ratios. Next, the film is immersed in a bath 520 of an aqueous solution containing boric acid and potassium iodide, and subjected to crosslinking treatment under tension in a longitudinal direction of the film by rollers 521 and 522 at different speed ratios. The film subjected to crosslinking treatment is immersed in a bath 530 of an aqueous solution containing potassium iodide by rollers 531 and 532, and subjected to water washing treatment. The film subjected to water washing treatment is dried by drying means 540 to adjust its moisture content at, for example 10 to 30%, and taken up in a take-up part 560. The polymer film 501 containing a polyvinyl alcohol-based resin as a main component may be stretched to a 5 to 7 times length of the original length through the above-mentioned process, to thereby provide a polarizer 550.

### D-1. Lamination of a Polarizer and a Retardation Layer

As a method of laminating the above-mentioned polarizer 30, any appropriate method can be adopted. Preferably, the polarizer 30 is attached to the above-mentioned retardation layer 20 via an adhesion layer (not shown). In this specification, the “adhesion layer” refers to a layer that connects the surfaces of adjacent optical members, thereby integrating them with a practically sufficient adhesion force and adhesion time. Examples of the adhesion layer include an adhesive layer, a pressure-sensitive adhesive layer, and an anchor coat layer.

The above-mentioned adhesion layer may have a multi-layered structure, for example, in which an anchor coat layer is formed on the surface of an adherend, and an adhesive layer or a pressure-sensitive adhesive layer is formed thereon, or may be a thin layer (which may also be referred to as a hair line) that cannot be recognized by the naked eye. By laminating a polarizer and a retardation layer as described above, when the laminate is incorporated into a liquid crystal display apparatus, the absorption axis direction of the polarizer can be prevented from being displaced from a predetermined position, and the polarizer and the retardation layer can be prevented from rubbing each other to be damaged. Further, the adverse effects of the reflection and refraction occurring at an interface between the polarizer and the retardation layer can be reduced, so a liquid crystal display apparatus capable of displaying a vivid image can be obtained.

The thickness of the above-mentioned adhesion layer can be set to be any appropriate value. The thickness is preferably 0.01 to 5.0 μm. If the thickness of the adhesion layer is in the above-mentioned range, the polarizer is not floated or peeled, and a practically sufficient adhesion force and an appropriate adhesion time can be obtained.

As a material forming the above-mentioned adhesion layer, any appropriate material can be selected depending upon the kind of an adherend. A material forming the adhesion layer is preferably a water-soluble adhesive mainly containing polyvinyl alcohol-based resin. This is because such an adhesive is excellent in adhesiveness with respect to the polarizer, and excellent in workability, productivity, and cost efficiency. As the above-mentioned water-soluble adhesive mainly containing a polyvinyl alcohol-based resin, a commercially available product can be used as it is. A solvent or an additive may be mixed with the commercially available product. Examples of the commercially available water-soluble adhesive mainly containing polyvinyl alcohol-based resin include GOHSENOL series (“NH-18S, GH-18S, T-330, etc.” (product name)) produced by Nippon Synthetic Chemical Industry, Co., Ltd., and GOHSEFIMER series (“Z-100, Z-200, Z-210, etc.” (product name)) produced by Nippon Synthetic Chemical Industry, Co., Ltd.

The above-mentioned adhesion layer may be obtained by cross-linking a composition obtained by blending a cross-linking agent with the above-mentioned water-soluble adhesive. As the cross-linking agent, any appropriate cross-linking agent can be adopted. Examples of the crosslinking agent include an amine compound, an aldehyde compound, a methylol compound, an epoxy compound, an isocyanate compound, and a polyvalent metal salt. A commercially available product may be used as it is as the crosslinking agent. Specific examples of the commercially available product include an amine compound “methaxylenediamine” (product name, produced by Mitsubishi Gas Chemical Company, Inc.), an aldehyde compound “Griokizal” (product name, produced by Nippon Synthetic Chemical Industry Co., Ltd.), and a methylol compound “WATERSOL” (product name, produced by Dainippon Ink and Chemicals, Incorporated).

### E. Other Layers

Practically, any appropriate protective layer (not shown) is provided on the polarizer 30 on a side where the retardation layer 20 is not laminated. By providing the protective layer, the polarizer can be prevented from contracting or expanding, and from being degraded with UV-rays. The thickness of the protective layer is preferably 20 to 100 μm. By setting the thickness in the above-mentioned range, a polarizing plate laminated with a retardation layer, excellent in mechanical strength and durability, can be obtained.

As the above-mentioned protective layer, any appropriate layer can be adopted. The protective layer is preferably a polymer film containing cellulose-based resin, norbornene-based resin, maleimide-based resin, or acrylic resin. Among them, a polymer film containing cellulose-based resin is used preferably. As the polymer film containing cellulose-based resin, preferably, films similar to those described in the above section C-1 are used.

In the case where the polarizing plate laminated with a retardation layer of the present invention is used in a liquid crystal display apparatus, the polarizing plate laminated with a retardation layer 100 is attached to a liquid crystal cell via the pressure-sensitive adhesive layer 10. That is, the above-mentioned protective layer is placed so as to be directed to a viewer side or a backlight side. At this time, on the outer side (on the side where the polarizer is not laminated) of the protective layer, a surface-treated layer can be placed for various purposes.

Examples of the above-mentioned surface-treated layer include a hard coat treated layer, an antistatic treated layer, a reflection prevention treated (anti-reflection treated) layer, a diffusion treated (anti-glare treated) layer. By placing such a surface-treated layer, the screen can be prevented from being contaminated and damaged, and fluorescent light in a room or a solar beam can be prevented from entering the screen to make it difficult to see a display image. The surface-treated layer is generally obtained by fixing a treatment agent forming each treated layer to the surface of a base film. The base film may also function as the above-mentioned protective layer. Further, the surface-treated layer may have a multi-layered structure in which, for example, a hard coat treated layer is laminated on an antistatic treated layer.

As the above-mentioned protective layer, a commercially available polymer film provided with a surface-treated layer can be used as it is. Alternatively, a commercially available polymer film subjected to any appropriate surface treatment may also be used. Examples of the commercially available diffusion treated (anti-glare treated) film include AG150, AGS1, AGS2, and AGT1 produced by Nitto Denko Corporation. Examples of the commercially available reflection prevention treatment (anti-reflection treatment) film include ARS and ARC produced by Nitto Denko Corporation. An example of a commercially available film subjected to hard coat treatment and antistatic treatment includes “KC8UX-HA” (product name) produced by Konica Minolta Opto, Inc. Examples of the commercially available surface-treated layer subjected to reflection prevention treatment include, for example, ReaLook series produced by NOF Corporation.

The above-mentioned protective layer is preferably laminated on the polarizer via the adhesion layer. As the adhesion layer, for example, those described in the above section D-1 are adopted.

In addition to the above-mentioned respective layers, between the respective layers and/or on the outer side of the respective layers shown in FIGS. 1(a) and 1(b), any appropriate optical compensation layer, adhesion layer, and the like are placed.

Practically, on a side of the pressure-sensitive adhesive layer 10 where the retardation layer 20 is not laminated, any appropriate peeling liner (not shown) can be placed.

### F. Entire Configuration of a Liquid Crystal Panel.

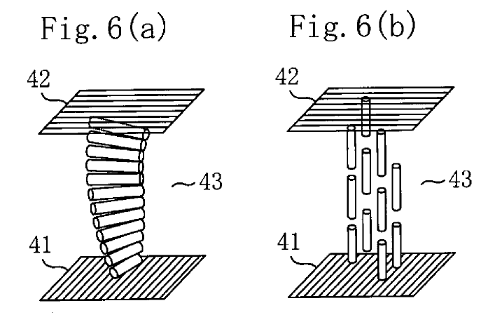

FIG. 5 is a schematic cross-sectional view of a liquid crystal panel according to a preferable embodiment of the present invention. The liquid crystal panel 101 includes a liquid crystal cell 40, a first polarizer 30 placed on one side of the liquid crystal cell 40, a second polarizer 30′ placed on the other side of the liquid crystal cell 40, a first retardation layer 20 placed between the first polarizer 30 and the liquid crystal cell 40, a second retardation layer 20′ placed between the second polarizer 30′ and the liquid crystal cell 40, a first pressure-sensitive adhesive layer 10 placed between the first retardation layer 20 and the liquid crystal cell 40, and a second pressure-sensitive adhesive layer 10′ placed between the second retardation layer 20′ and the liquid crystal cell 40. That is, the liquid crystal panel 101 includes the liquid crystal cell 40, a polarizing plate laminated with a retardation layer 100 of the present invention placed on one side of the liquid crystal cell 40, and a polarizing plate laminated with a retardation layer 100′ of the present invention placed on the other side of the liquid crystal cell. The details of the polarizing plates laminated with a retardation layer 100, 100′ are as described in the above sections A to E.

In addition to the above-mentioned respective layers, between the respective layers and/or on the outer side of the respective layers shown in FIG. 5, any appropriate compensation layer, adhesion layer, and the like may be placed.

### G. Liquid Crystal Cell

The liquid crystal cell 40 includes a pair of glass substrates 41, 42, and a liquid crystal layer 43 as a display medium placed between the substrates. On one substrate (active matrix substrate) 41, switching elements (typically, TFTs) for controlling the electrooptical characteristics of liquid crystal, and scanning lines that provide a gate signal to the switching elements and signal lines that give a source signal thereto are provided (both of them are not shown). On the other substrate (color filter substrate) 42, a color filter (not shown) is provided. The color filter may be provided on the active matrix substrate 41. The gap (cell gap) between the substrates 41 and 42 is controlled with spacers 44. On each side of the substrates 41 and 42, which is in contact with the liquid crystal layer 43, an alignment film (not shown) made of, for example, polyimide is provided. As a method of forming the alignment film, any appropriate alignment treatment method can be adopted. Specific examples of the alignment treatment method include rubbing, oblique deposition, and optical alignment.

As the driving mode of the liquid crystal cell 40, any appropriate driving mode can be adopted, as long as the effects of the present invention are obtained. Specific examples of the driving mode include a super twisted nematic (STN) mode, a twisted nematic (TN) mode, an in-plane switching (IPS) mode, a vertical aligned (VA) mode, an optically aligned birefringence (OCB) mode, a hybrid aligned nematic (HAN) mode, and an axially symmetric aligned microcell (ASM) mode. The TN mode is preferable. This is because the effects of the present invention can be exhibited more by combining the retardation layer 20 (20′) with the pressure-sensitive adhesive layer 10 (10′) used in the present invention.

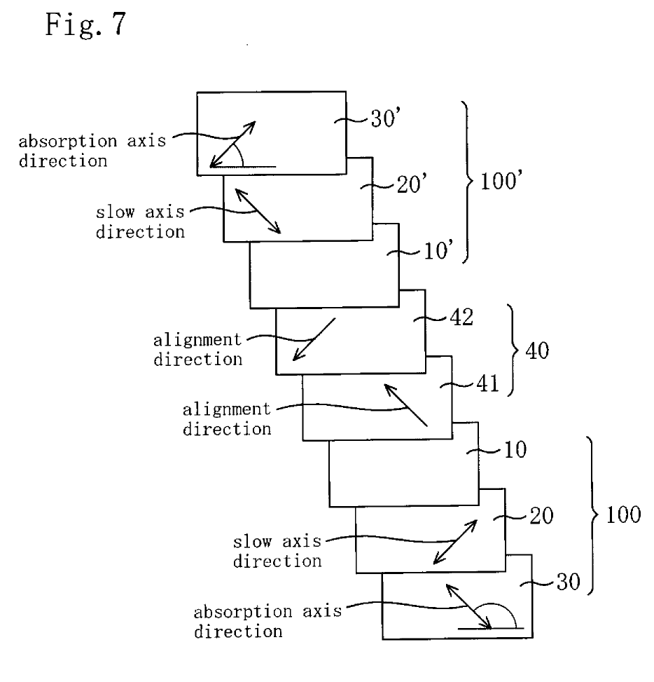

FIGS. 6(a) and 6(b) are schematic perspective views illustrating the alignment state of liquid crystal molecules in the TN mode. The substrates 41 and 42 are placed so that the respective alignment directions are substantially perpendicular to each other. Since the alignment directions of the substrates 41 and 42 are substantially perpendicular to each other, the liquid crystal molecules of the liquid crystal layer 43 are substantially in an alignment state having a 90°-twisted structure under the application of no voltage as shown in FIG. 6(a). More specifically, the alignment of liquid crystal molecules changes gradually and continuously so as to be substantially parallel to the alignment direction of the surface of each facing substrate with distance from the center of the liquid crystal layer. Such an alignment state can be realized by placing nematic liquid crystal having positive dielectric anisotropy between alignment films having a predetermined alignment regulating force. When light is allowed to be incident from the surface of one substrate 41 in such a state, the liquid crystal molecules exhibit birefringence with respect to the linearly polarized light which passed through the first polarizer 30 to be incident upon the liquid crystal layer 43, and the polarization state of the incident light changes in accordance with the twist of the liquid crystal molecules. The light passing through the liquid crystal layer under the application of no voltage becomes, for example, linearly polarized light with a polarization direction thereof rotated by 90°, so the light passes through the second polarizer 30′, whereby a display in a bright state is obtained (normally white mode).

As described above, the liquid crystal molecules of the liquid crystal layer 43 have positive dielectric anisotropy. Thus, when a voltage is applied between electrodes, as shown in FIG. 6(b), the liquid molecules of the liquid crystal layer 43 are aligned vertically to the surfaces of the substrates 41 and 42. When light is allowed to be incident from the surface of one substrate 41 in such a state, the linearly polarized light which passed through the first polarizer 30 to be incident upon the liquid crystal layer 43 travels in a direction of the major axis of the liquid crystal molecules aligned vertically. Since birefringence does not occur in the direction of the major axis of the liquid crystal molecules, the incident light travels without changing a polarization direction, and is absorbed by the second polarizer 30′ having an absorption axis perpendicular to the first polarizer 30. Consequently, a display in a dark state is obtained under the application of a voltage. When the application state is brought back to the application of no voltage, a display in a bright state can be obtained again by an alignment regulating force. Further, by changing an applied voltage to control the tilt of the liquid crystal molecules so as to change the intensity of transmitted light from the second polarizer 30′, a gray-scale display can be performed.

### H. Optical Axis Relationship of Respective Layers

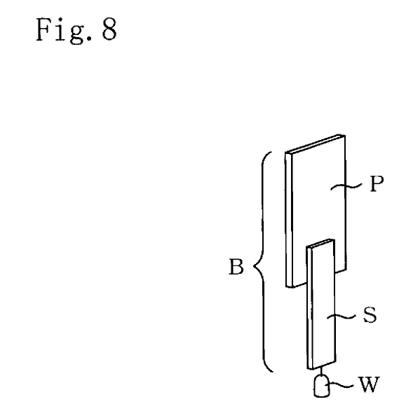

FIG. 7 is an exploded perspective diagram illustrating an optical axis of each layer constituting the liquid crystal panel 101 of FIG. 5. The first polarizer 30 and the second polarizer 30′ are typically placed so that absorption axes thereof are substantially perpendicular to each other. The first polarizer 30 is typically placed so that an absorption axis thereof is substantially parallel to the alignment direction of the substrate 41 of the liquid crystal cell 40. Further, the second polarizer 30′ is typically placed so that an absorption axis thereof is substantially parallel to the alignment direction of the substrate 42 of the liquid crystal cell 40.

The slow axis direction of the retardation layer 20 (20′) is substantially perpendicular to the absorption axis direction of the polarizer 30 (30′). In one embodiment, the slow axis direction of the retardation layer 20 (20′) is 45° (or 1350) with respect to one side of the liquid crystal panel (see FIG. 2(a)). In another embodiment, the slow axis direction of the retardation layer 20 is 90° (or 0°) with respect to one side of the liquid crystal panel (see FIG. 2(b)). Preferably, as shown in FIG. 4(a), the retardation layer 20 is placed so that the slow axis direction is 45° (or 135°) with respect to one side of the liquid crystal panel. In the case of adopting such arrangement, the contrast ratio in the front direction can be enhanced remarkably. Further, in the case where a screen is viewed in an oblique direction, a constant contrast ratio can be obtained even when viewed from any azimuth angles of 0° to 360°.

The laminating order of the respective layers constituting the liquid crystal panel of the present invention is not particularly limited.

Hereinafter, the present invention will be described specifically by way of examples. However, the present invention is not limited to these examples. Each analysis method used in each example and comparative example is as follows.

### 1. Regarding a Pressure-Sensitive Adhesive Layer

### (1) Measurement Method of a Holding Force

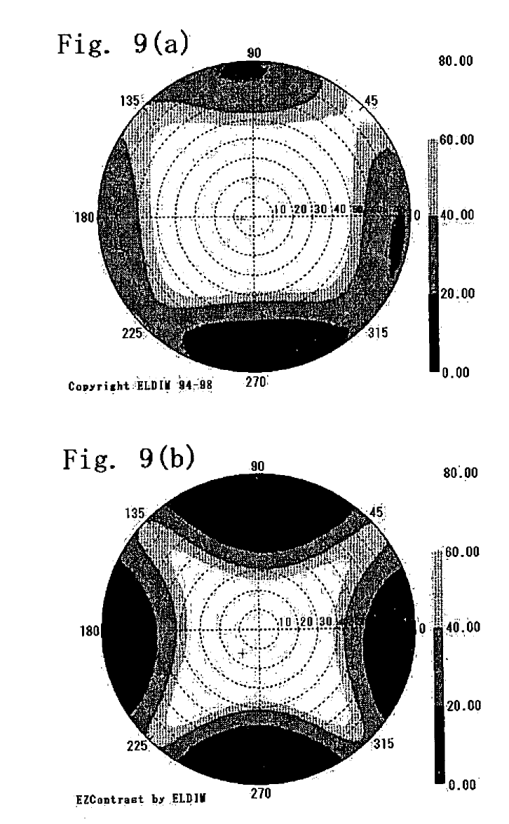

As to be described later, a test piece S (polarizing plate laminated with a retardation layer) of 10 mm×30 mm was produced. As shown in FIG. 8, an upper end portion of 10 mm×10 mm of the test piece S was attached to a bake plate P via a pressure-sensitive adhesive layer to obtain a test plate B. Then, the obtained test plate B was subjected to autoclave treatment at 50° C. for 15 minutes under the condition of a pressure of 5 atmospheres, and thereafter, the test plate B was allowed to stand for one hour at room temperature.

After that, as shown in FIG. 8, the lower end portion of the test piece S was supplied with a weight W of 500 g and allowed to stand for one hour in a thermostat at 60° C. The displacement width (holding force H_{A}) between the test piece S and the bake plate P after the test plate B was allowed to stand was measured by a laser creep tester.

After the test plate B was subjected to autoclave treatment as described above, the test plate B was allowed to stand in a chamber at 23° C. for one hour with a weight W of 500 g applied to the lower end portion of the test piece S. The displacement width (holding force H_{B}) between the test piece S and the bake plate P after the test plate B was allowed to stand was measured by the laser creep tester.

### (2) Measurement Method of a Thickness

In the case where the thickness is less than 10 μm, the thickness was measured using a spectrophotometer for a thin film [“Instantaneous multi-measurement system MCPD-2000” (product name) produced by Otsuka Electronics Co., Ltd.]. In the case where the thickness is 10 μm or more, the thickness was measured using a digital micrometer “KC-351C type” produced by Anritsu Corporation.

### (3) Measurement Method of a Transmittance (T[590])

The transmittance was measured with light having a wavelength of 590 nm at 23° C., using an ultraviolet and visible spectrophotometer [“V-560” (product name) produced by JASCO Corporation].

### (4) Measurement Method of a Gel Fraction of a Pressure-Sensitive Adhesive

A sample of a pressure-sensitive adhesive whose weight had been measured in advance was placed in a container filled with ethyl acetate and allowed to stand at 23° C. for 7 days. After that, the pressure-sensitive adhesive was taken out, and a solvent was wiped off. Then, the weight of the sample was measured. The gel fraction was obtained by the following expression: {(W_{A}−W_{B})/W_{A}×100}. Herein, W_{A} is the weight of the pressure-sensitive adhesive layer before being placed in ethyl acetate, and W_{B} is the weight of the pressure-sensitive adhesive layer after being placed in ethyl acetate.

### (5) Measurement Method of a Glass Transition Temperature (Tg)

The glass transition temperature was obtained by a DSC method according to JIS K7121, using a differential scanning calorimeter, “DSC220C” (product name) produced by Seiko Instruments Inc.

### (6) Measurement Method of a Moisture Content

A pressure-sensitive adhesive layer was placed in an air circulation thermostatic oven at 150° C., and the moisture content was obtained from a weight reduction ratio {(W₁−W₂)/W₁×100} after the elapse of one hour. Herein, W₁ is the weight of the pressure-sensitive adhesive layer before being placed in the air circulation thermostatic oven, and W₂ is the weight of the pressure-sensitive adhesive layer after being placed in the air circulation thermostatic oven.

### (7) Measurement Method of a Molecular Weight

The molecular weight was calculated using polystyrene as a standard sample by gel permeation chromatography (GPC). Specifically, the molecular weight was measured by the following apparatus and appliance under the following measurement conditions. As a measurement sample, a filtrate was used, which was obtained by dissolving the obtained pressure-sensitive adhesive in tetrahydrofuran to obtain a 0.1% by weight of solution, allowing the solution to stand still overnight, and filtering the solution with a membrane filter of 0.45 μm.

Analysis apparatus: “HLC-8120GPC” produced by Tosoh Corporation

Column: TSKgel SuperHM-H/H4000/H3000/H2000

Column size: each 6.0 mm I.D.×150 mm

Eluent: tetrahydrofuran

Flow rate: 0.6 ml/min.

Detector: RI

Column temperature: 40° C.

Injection amount: 20 μl

### 2. Regarding Optical Characteristics

### (1) Measurement Method of an Average Refractive Index of a Film

The average refractive index was obtained from a refractive index measured with light having a wavelength of 589 nm at 23° C., using an Abbe refractometer [“DR-M4” (product name) produced by Atago Co., Ltd.].

### (2) Measurement Method of a Retardation Value (Re[590], Rth[590]) and an Average Inclination Angle

The retardation value and the average inclination angle were measured with light having a wavelength of 590 nm at 23° C., using “KOBRA21-ADH” (product name) produced by Oji Scientific Instruments. Using an in-plane retardation value (Re) of each wavelength at 23° C., a retardation value (R40) measured by inclining a slow axis by 40° as an inclination axis with respect to a normal axis of a retardation layer, a thickness (d) of the retardation layer, and an average refractive index (n0) of the retardation layer, nx, ny, and nz are obtained by computer numerical computation, whereby Rth can be calculated.

(3) Measurement Method of a Single Axis Transmittance, a Polarization Degree, a Hue a-Value, and a Hue B-Value of a Polarizing Plate.

The single axis transmittance, polarization degree, hue a-value, and hue b-value of a polarizing plate were measured at 23° C., using a spectrophotometer [“DOT-3” (product name) produced by Murakami Color Research Laboratory Co., Ltd.]. The polarization degree can be obtained from an expression: Polarization (%)={(H₀−H₉₀)/(H₀+H₉₀)}^{1/2}×100, measuring the parallel transmittance (H₀) and the perpendicular transmittance (H₉₀) of a polarizer. The parallel transmittance (H₀) is a value of a transmittance of a parallel laminated polarization layer produced by stacking the same two polarizers so that the absorption axes are parallel to each other. The perpendicular transmittance (H₉₀) is a value of a transmittance of a perpendicular laminated polarization layer produced by stacking the same two polarizers so that the absorption axes are perpendicular to each other. These transmittances are Y-values obtained by correcting a spectral luminous efficacy by a second degree visual field (C light source) of JIS Z8701-1982.

### (4) Measurement Method of a Contrast Ratio of a Liquid Crystal Display Apparatus

After the elapse of 30 minutes from the lighting of a backlight in a dark room at 23° C., a Y-value of an XYZ display system in the case of displaying a white image and a black image was measured, using “EZ Contrast 160D” (product name) produced by ELDIM, Inc. A contrast ratio “YW/YB” in an oblique direction was calculated from a Y-value (YW) in a white image and a Y-value (YB) in a black image. The long side of a liquid crystal panel was defined as an azimuth angle 0°, and the normal direction was defined as a polar angle θ′.

### EXAMPLE 1

### Production of a Pressure-Sensitive Adhesive Layer

To a reaction container equipped with a cooling tube, a nitrogen introducing tube, a thermometer, and a stirring device, 99 parts by weight of butylacrylate, 1.0 part by weight of 4-hydroxybutylacrylate, 0.3 parts by weight of 2,2-azobisisobutylonitrile, and ethyl acetate were added, whereby a solution was prepared. Then, the solution was stirred while nitrogen gas was being blown into the solution to effect a polymerization reaction at 60° C. for 4 hours, whereby an acrylic copolymer with a weight average molecular weight of 1,650,000 was obtained.

Ethyl acetate was further added to the obtained acrylic copolymer to dilute the solution, whereby 30% by weight of a total solid content of a polymer solution (1-A) was prepared. Next, 0.3 parts by weight of dibenzoylperoxide [“NYPER BO-Y” (product name) produced by NOF Corporation], 0.18 parts by weight of trimethyrolpropane xylylene diisocyanate [“Takenate D110N” (product name) produced by Mitsui Chemicals Polyurethanes, Inc.], and 0.2 parts by weight of a silane coupling agent containing an acetoacetyl group [“A-100” (product name) produced by Soken Chemical & Engineering Co., Ltd.] were blended in this order with the polymer solution (1-A), based on 100 parts by weight of the acrylate copolymer, whereby a polymer solution (1-B) was prepared.

The obtained polymer solution (1-B) was applied uniformly onto the surface of a substrate (a polyethylene terephthalate film treated with a silicone release agent) using a fountain coater. After that, the polymer solution (1-B) was dried in an air circulation type temperature-controlled oven at 155° C. for 70 seconds, whereby a pressure-sensitive adhesive layer was formed on the surface of the substrate. The pressure-sensitive adhesive layer thus obtained had a holding force (H_{A}) of 120 μm, a holding force (H_{B}) of 80 μm, a transmittance (T[590]) of 92%, a gel fraction of 84%, a glass transition temperature (Tg) of −38° C., and a moisture content of 0.25%.

### (Production of Polarizer)

A polymer film “9P75R” (product name, thickness of 75 μm, average degree of polymerization of 2,400, degree of saponification of 99.9 mol %, produced by Kuraray Co., Ltd.) containing as a main component polyvinyl alcohol was uniaxially stretched 2.5 times by using a roll stretching machine while the polymer film was colored in a coloring bath maintained at 30±3° C. and containing a mixture of iodine and potassium iodide. Next, the polyvinyl alcohol film was uniaxially stretched to a 6 times length of the original length in a bath maintained at 60±3° C. and containing an aqueous solution of a mixture of boric acid and potassium iodide while a crosslinking reaction was performed. The obtained film was dried in an air circulating thermostatic oven at 50±1° C. for 30 minutes, to thereby obtain a polarizer.

### (Retardation Layer)

As a retardation layer including a resin layer and an inclined alignment layer which is formed of a liquid crystalline composition containing a discotic compound and in which the discotic compound is aligned so as to be inclined, “WV film EA” (product name) produced by Fujifilm Corporation, was used. The film had an Re[590] of 40 nm, an Rth[590] of 155 nm, a Nz coefficient of 3.9, and an average inclination angle of 16.00.

(Production of a Polarizing Plate Laminated with a Retardation Layer)

The inclined alignment layer side of the above-mentioned retardation layer was subjected to corona treatment (1.2 kW/15 m/min.). On the corona-treated surface, the pressure-sensitive adhesive layer formed on the surface of the above-mentioned substrate was laminated to obtain a laminate A. At this time, the pressure-sensitive adhesive layer was laminated so that the pressure-sensitive adhesive layer was placed on the corona-treated surface side. Then, the laminate A was aged for 7 days in the air circulation type temperature-controlled oven at 70° C. The thickness of the pressure-sensitive adhesive layer was 21 μm. On the retardation layer (resin layer) side of the aged laminate A, the polarizer obtained in the above was laminated via a polyvinyl alcohol-based adhesive (thickness: 0.1 μm). Further, on the other side of the polarizer (on the side where the laminate A was not laminated), a protective layer [triacetylcellulose film, produced by Fujifilm Corporation, FUJITAC (product name)] was laminated via a polyvinylalcohol adhesive (thickness: 0.1 μm), whereby a polarizing plate laminated with a retardation layer was obtained.

### (Production of a Liquid Crystal Display Apparatus)

A liquid crystal panel was taken out from a commercially available liquid crystal display apparatus (“FP71E+” (product name) produced by BenQ Corporation) including a TN mode liquid crystal cell, and optical films such as a polarizing plate placed on upper and lower sides of the liquid crystal cell were all removed. A glass substrates (on front and reverse sides) of the obtained liquid crystal cell was washed to obtain a liquid crystal cell A. The polarizing plates laminated with a retardation layer obtained in the above were attached to both sides of the liquid crystal cell A to obtain a liquid crystal panel A. At this time, as shown in FIG. 7, the polarizing plates were attached to the liquid crystal cell A so that absorption axes of polarizers 30, 30′ were substantially perpendicular to each other. Further, the polarizing plates were attached to the liquid crystal cell A so that the absorption axes of the polarizers 30 (30′) were substantially parallel to the alignment direction of adjacent glass substrates 41 (42) of the liquid crystal cell 40. The obtained liquid crystal panel A was combined with a backlight unit to obtain a liquid crystal display apparatus A.

### EXAMPLE 2

A polarizing plate laminated with a retardation layer and a liquid crystal display apparatus were produced in the same way as in Example 1, except that a pressure-sensitive adhesive layer was produced using 0.12 parts by weight of trimethylolpropane xylylene diisocyanate, with respect to 100 parts by weight of the above-mentioned acrylate copolymer. The obtained pressure-sensitive adhesive layer had a holding force (H_{A}) of 150 μm, a holding force (H_{B}) of 100 μm, a transmittance (T[590]) of 92%, a gel fraction of 82%, a glass transition temperature (Tg) of −38° C., and a moisture content of 0.25%.

### EXAMPLE 3

A polarizing plate laminated with a retardation layer and a liquid crystal display apparatus were produced in the same way as in Example 1, except for using “WV film SA” (product name) produced by Fujifilm Corporation as the retardation layer. The film had an Re[590] of 35 nm, an Rth[590] of 155 nm, an Nz coefficient of 4.43, and an average inclination angle of 18.9°.

### EXAMPLE 4

A polarizing plate laminated with a retardation layer and a liquid crystal display apparatus were produced in the same way as in Example 1, except for using “WV film A” (product name) produced by Fujifilm Corporation as the retardation layer. The film had an Re[590] of 21.9 nm, an Rth[590] of 140 nm, an Nz coefficient of 6.4, and an average inclination angle of 15.20.

### COMPARATIVE EXAMPLE 1

A polarizing plate laminated with a retardation layer and a liquid crystal display apparatus were produced in the same way as in Example 1, except for using 0.02 parts by weight of trimethylolpropane xylylene diisocyanate, with respect to 100 parts by weight of the above-mentioned acrylate copolymer. The obtained pressure-sensitive adhesive layer had a holding force (H_{A}) of 380 μm, a holding force (H_{B}) of 250 μm, a transmittance (T [590]) of 92%, a gel fraction of 72%, a glass transition temperature (Tg) of −38° C., and a moisture content of 0.27%.

### COMPARATIVE EXAMPLE 2

A polarizing plate and a liquid crystal display apparatus were produced in the same way as in Example 1, except that a retardation layer was not provided.

The liquid crystal display apparatuses of Examples 1, 3, and 4 of the present invention and the liquid crystal display apparatus of Comparative Examples 1 and 2 immediately after a backlight was lit had satisfactory display uniformity over an entire surface.

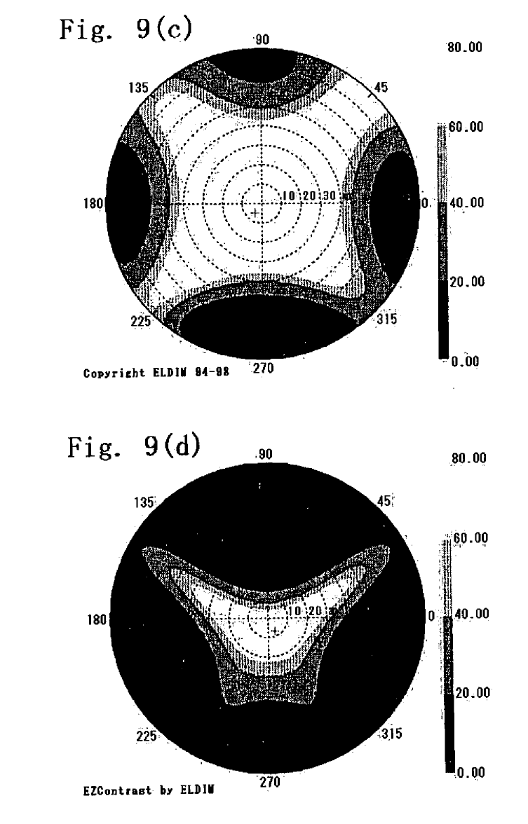

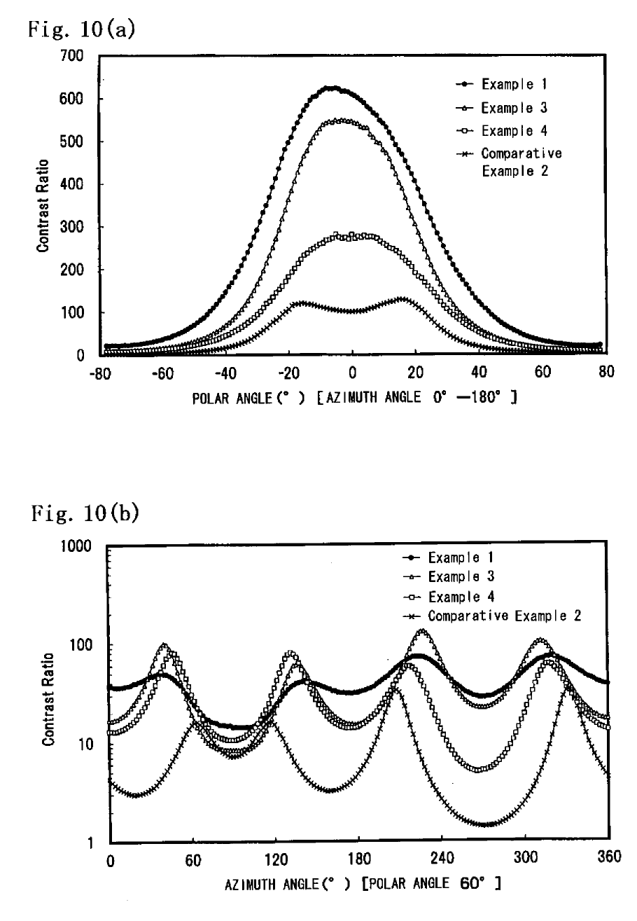

A contrast contour map of FIGS. 9(a) to 9(d) show the viewing angle dependence of the contrast of the polarizing plates laminated with a retardation layer obtained in Examples 1, 3, and 4, and the polarizing plate of Comparative Example 2. Further, FIGS. 10(a) and 10(b) show the polar angle dependence and azimuth angle dependence of a contrast ratio. As is apparent from FIGS. 9(a) to 9(d) and 10(a) and 10(b), it is understood that the liquid crystal display apparatus of Examples of the present invention are excellent in both a contrast in a front direction and a contrast in an oblique direction, compared with the liquid crystal display apparatus of Comparative Examples.

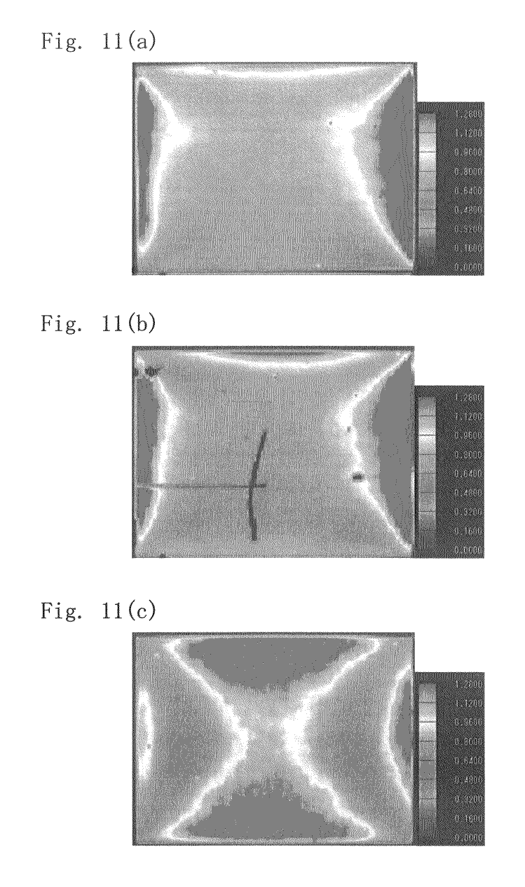

Liquid crystal panels obtained using the polarizing plates laminated with a retardation layer in Example 1, Example 2, and Comparative Example 1 were stored in an air circulation type temperature-controlled oven at 60° C. for 100 hours, and then taken out to room at 23° C. Regarding each of these liquid crystal panels, a liquid crystal display apparatus was produced as described above, and observed for the occurrence of display unevenness at a time of a black image display. The observation was conducted by photographing a display screen in a dark room at 23° C., using a two-dimensional color distribution measurement apparatus [[CA-1500] (product name) produced by Konica Minolta Opto, Inc.]. FIGS. 11(a) to (c) show the observed photographs thereof. As shown in FIGS. 11(a) and (b), in the liquid crystal display apparatuses of Examples 1 and 2, the display unevenness was suppressed satisfactorily. On the other hand, as shown in FIG. 11(c), in the liquid crystal display apparatus in Comparative Example 1, unevenness occurred on an entire screen.

### INDUSTRIAL APPLICABILITY

The polarizing plate laminated with a retardation layer, the liquid crystal panel, and the liquid crystal display apparatus according to the present invention can be preferably used in, for example, OA appliances such as a personal computer monitor, a notebook computer, and a copying machine, mobile appliances such as a mobile telephone, a clock, a digital camera, a personal digital assistant (PDA), and a mobile game machine, household electric appliances such as a video camera, a television, and a microwave oven, vehicle appliances such as a back monitor, a car navigation system monitor, and an audio device for a vehicle, display appliances such as an information monitor for a commercial shop, guard appliances such as a surveillance monitor, and care-giving and medical appliances such as a caregiving monitor and a medical monitor.

1. A polarizing plate laminated with a retardation layer, comprising:
a pressure-sensitive adhesive layer;
a retardation layer including a resin layer and an inclined alignment layer; and
a polarizer, in this order, wherein:
a holding force (H_{A}) of the pressure-sensitive adhesive layer at 60° C. is 300 μm or less;
a slow axis direction of the retardation layer is substantially perpendicular to an absorption axis direction of the polarizer; and
the inclined alignment layer is formed of a liquid crystalline composition containing a discotic compound, and the discotic compound is aligned to be inclined.

2. A polarizing plate laminated with a retardation layer according to claim 1, wherein a difference (H_{A}−H_{B}) between the holding force (H_{A}) of the pressure-sensitive adhesive layer at 60° C. and a holding force (H_{B}) thereof at 23° C. is 100 μm or less.

3. A polarizing plate laminated with a retardation layer according to claim 1, wherein a moisture content of the pressure-sensitive adhesive layer is 1.0% or less.

4. A polarizing plate laminated with a retardation layer according to claim 1, wherein a gel fraction of the pressure-sensitive adhesive layer is 75% or more.

5. A polarizing plate laminated with a retardation layer according to claim 1, wherein the pressure-sensitive adhesive layer is formed by cross-linking a pressure-sensitive adhesive composition at least containing (meth)acrylic polymer (A) and a peroxide (B).

6. A polarizing plate laminated with a retardation layer according to claim 5, wherein the (meth)acrylic polymer (A) is a copolymer of alkyl(meth)acrylate (a1) and hydroxy-containing (meth)acrylate (a2).

7. A polarizing plate laminated with a retardation layer according to claim 5, wherein a blending amount of the peroxide (B) is 0.01 to 1 parts by weight with respect to 100 parts by weight of the (meth)acrylic polymer (A).

8. A polarizing plate laminated with a retardation layer according to claim 5, wherein the pressure-sensitive adhesive composition further contains an isocyanate compound.

9. A polarizing plate laminated with a retardation layer according to claim 8, wherein a blending amount of the isocyanate compound is 0.04 to 1 parts by weight with respect to 100 parts by weight of the (meth)acrylic polymer (A).

10. A polarizing plate laminated with a retardation layer according to claim 1, wherein an index ellipsoid of the resin layer has a relationship of nx≧ny>nz.

11. A polarizing plate laminated with a retardation layer according to claim 1, wherein the rein layer comprises a polymer film containing cellulose-based resin.

12. A polarizing plate laminated with a retardation layer according to claim 1, wherein the discotic compound comprises a triphenylene discotic compound.

13. A polarizing plate laminated with a retardation layer according to claim 1, wherein an in-plane retardation Re[590] of the retardation layer is 20 to 80 nm.

14. A polarizing plate laminated with a retardation layer according to claim 1, wherein a thickness direction retardation Rth[590] of the retardation layer is 100 to 300 nm.

15. A polarizing plate laminated with a retardation layer according to claim 1, wherein an Nz coefficient of the retardation layer is 2 to 8.

16. A polarizing plate laminated with a retardation layer according to claim 1, wherein an average inclination angle of the retardation layer is 8 to 24°.

17. A polarizing plate laminated with a retardation layer according to claim 1, wherein the polarizer comprises a stretched film mainly containing polyvinyl alcohol resin containing iodine or dichroic dye.

18. A liquid crystal panel, comprising:
a liquid crystal cell;
the polarizing plate laminated with a retardation layer according to claim 1, which is placed on one side of the liquid crystal cell so that the pressure-sensitive adhesive layer is on the liquid crystal cell side; and
the polarizing plate laminated with a retardation layer according to claim 1, which is placed on another side of the liquid crystal cell so that the pressure-sensitive adhesive layer is on the liquid crystal cell side.

19. A liquid crystal panel according to claim 18, wherein the liquid crystal cell is in a TN mode.

20. A liquid crystal display apparatus, comprising the liquid crystal panel according to claim 18.
